(19) United States
(12) Patent Application Publication
(10) Pub. No.: US 2015/0336271 A1
(43) Pub. Date: Nov. 26, 2015

(54) SYSTEM AND METHOD FOR FIXTURELESS COMPONENT LOCATION IN ASSEMBLING COMPONENTS

(71) Applicant: GM GLOBAL TECHNOLOGY OPERATIONS LLC, Detroit, MI (US)

(72) Inventors: John Patrick Spicer, Plymouth, MI (US); Yhu-Tin Lin, Rochester Hills, MI (US); Ryan C. Sekol, Grosse Pointe Woods, MI (US); Neil David McKay, Chelsea, MI (US); Jianying Shi, Oakland Township, MI (US); Mark A. Smith, Huntington Woods, MI (US); Robert Bruce Tilove, Rochester Hills, MI (US); Muhammad E. Abdallah, Rochester Hills, MI (US); Seog-Chan Oh, Troy, MI (US); Raymond Guo, Seabrook, TX (US); Lance T. Ransom, Essex (CA)

(73) Assignee: GM GLOBAL TECHNOLOGY OPERATIONS LLC, Detroit, MI (US)

(21) Appl. No.: 14/714,825

(22) Filed: May 18, 2015

Related U.S. Application Data
(60) Provisional application No. 62/000,829, filed on May 20, 2014.
(60) Provisional application No. 62/008,659, filed on Jun. 6, 2014.
(60) Provisional application No. 62/008,660, filed on Jun. 6, 2014.
(60) Provisional application No. 62/008,663, filed on Jun. 6, 2014.
(60) Provisional application No. 62/000,823, filed on May 20, 2014.
(60) Provisional application No. 62/079,326, filed on Nov. 13, 2014.

(51) Int. Cl. B25J 9/16; B23P 19/04; B32B 7/14; B25J 19/02; B32B 37/26; B32B 41/00; B23K 31/12; B23K 37/04; B23P 15/00; B32B 7/06

(52) U.S. Cl. CPC B25J 9/1687; B23P 15/00; B23P 19/04; B32B 7/14; B32B 7/06; B32B 37/26; B32B 41/00; B23K 31/12; B23K 37/04; B25J 9/1697; B25J 19/02; B25J 9/1682; B23P 2700/50; B32B 2037/268; Y10S 901/09

(57) ABSTRACT

A system for assembling a first component and a second component comprises a support operatively supporting the first component without any fixtures, a vision system configured to view the supported first component and the second component and determine the locations thereof, a robotic system configured to move and position the second component relative to the first component, and a controller operatively connected to the vision system and to the robotic system and operable to control the robotic system to position the second component relative to the first component based on the locations determined by the vision system. Various methods of assembling the first component and the second component are provided to create a process joint prior to creation of a structural joint in a subsequent assembly operation.

### CROSS-REFERENCE TO RELATED APPLICATIONS

This application claims the benefit of U.S. Provisional Application No. 62/000,829, filed May 20, 2014; U.S. Provisional Application No. 62/008,659, filed Jun. 6, 2014; U.S. Provisional Application No. 62/008,660, filed Jun. 6, 2014; U.S. Provisional Application No. 62/008,663, filed Jun. 6, 2014; U.S. Provisional Application No. 62/000,823, filed May 20, 2014; and U.S. Provisional Application No. 62/079,326, filed Nov. 13, 2014, which are hereby incorporated by reference in their entirety.

### TECHNICAL FIELD

The present teachings generally include a system and a method for component locating during assembly of assembling multiple component items, such as but not limited to vehicle body components, boats, construction equipment, lawn equipment, or robots.

### BACKGROUND

Vehicle bodies are comprised of a multitude of structural components that must be assembled to one another with sufficient precision for proper function and aesthetics. The body includes multiple subassemblies each having a number of subcomponents. Typically, dedicated fixtures are designed for presenting and positioning each subcomponent relative to one or more subcomponents to which it is to be assembled. These fixtures require an extended lead time and significant capital investment to design and manufacture prior to use in assembling the body components. Additionally, the fixtures occupy a large amount of floor space.

### SUMMARY

A system for assembling a first component and a second component to one another includes a support operatively supporting the first component without any fixtures. In some embodiments, the components may be metals (steel, aluminum, magnesium and their alloys), plastics, or composite materials such as carbon fiber or fiberglass. Additionally, the components may be vehicle structural components, such as vehicle body components, but are not limited to such. The components may be for an automotive vehicle, or a non-automotive vehicle, such as a farm vehicle, a marine vehicle, an aviation vehicle, etc. It is to also be appreciated that the components can be assembled to create appliances, construction equipment, lawn equipment, robots, etc., instead of vehicles. The purpose or function of the support is to keep the first component from unwanted shifting, deflection or deformation during the assembly operation. In some embodiments, the support is reconfigurable for use with different components. The system includes a vision system configured to view the supported first component and the second component and determine the locations thereof. A robotic system is configured to move and position the second component relative to the first component. A controller is operatively connected to the vision system and to the robotic system and operable to control the robotic system to position the second component relative to the first component based on the locations determined by the vision system. A process joining system may be used to join (i.e., hold) the components together with one or more “process joints” after they have been located with respect to each other in order to create the correct subassembly geometry (i.e. geo-set).

As used herein, a “process joint” includes any mechanisms or modes by which the first component and the second component are maintained in a predetermined relative position. In different embodiments, the process joint may be established by mechanical features, mechanical joining methods, fusion bonding methods, solid state bonding methods, adhesive, or by cooperative positioning control of robotic arms. Mechanical joining methods include rivets, flow drill screws, and mechanical clinching. Fusion bonding methods include laser welding and resistance spot welding. Solid state bonding methods include friction stir welding and ultrasonic welding. Other hybrid joining methods comprised of and combinations of these individual methods may be utilized. Elastic averaging may be utilized when mechanical features establish the process joint. The controller may use a hybrid of positioning and force control to move the one or more robotic arms to meet both force constraints and positioning requirements. The various process joints and the vision system may enable rapid one-sided or two-sided re-spot welding, such as but not limited to remote laser welding or resistance spot welding.

In an embodiment, the first component has a first feature, and the second component has a second feature complementary to the first feature such that the first feature and the second feature establish a process joint configured with a predetermined strength sufficient to maintain the second vehicle component relative to the first vehicle component in the location determined by the vision system.

In an embodiment, the first feature is a first fastening feature and the second feature is second fastening feature that is configured to engage with the first fastening feature.

In an embodiment, an adhesive is positioned between the first component and the second component establishing a process joint configured with a predetermined strength sufficient to maintain the second vehicle component relative to the first vehicle component in the location determined by the vision system. For example, the adhesive may have a thickness establishing a standoff distance between the first component and the second component, and the standoff distance may be correlated with a subsequent structural weld of the first component to the second component.

In an embodiment, binder-coated particles are positioned between the first component and the second component establishing a process joint configured with a predetermined strength sufficient to maintain the second vehicle component relative to the first vehicle component in the location determined by the vision system. The binder-coated particles may have a thickness establishing a standoff distance between the first component and the second component, and the standoff distance may be correlated with a subsequent structural weld of the first component to the second component.

In an embodiment, a releasable adhesive is positioned between the first component and the second component establishing a process joint configured with a predetermined strength sufficient to maintain the second vehicle component relative to the first vehicle component in the location determined by the vision system. The releasable adhesive establishes a standoff distance between the first component and the second component, and the standoff distance is correlated with a subsequent structural weld of the first component to the second component.

In an embodiment, the support includes a shape memory polymer material having a temporary shape and a permanent shape. The shape memory polymer establishes the permanent shape upon application of a predetermined activation stimulus. The temporary shape is complementary to at least a portion of an outer surface of the first component. The support maintains the temporary shape during assembly of the first and the second components.

In an embodiment, the support includes a three-dimensional printed plastic core conforming to an outer surface of the first component, and a liner covering a surface of the three-dimensional printed plastic core.

In an embodiment, the robotic system has a force sensor, and the controller controls the robotic system to establish a predetermined holding force of the second component against the first component using a force level determined from the force sensor.

In an embodiment, the robotic system establishes a standoff distance between the first component and the second component, and the standoff distance is correlated with a subsequent structural weld of the first component to the second component.

In an embodiment, the robotic system includes a first robotic arm operatively holding the second component in the location determined by the vision system to establish a process joint with the support, and a second robotic arm configured to weld the first component to the second component while the first robotic arm holds the second component in the location determined by the vision system. In such an embodiment, the support may be another robotic arm or a repositionable support.

In an embodiment, the support includes a plurality of slidable pins configured to slide in unison different respective distances in conformance with an outer surface of the first component when the first component is placed on the slidable pins, the support thereby conforming to the outer surface of the first component.

A method of assembling components includes determining a location of an unfixtured first component via a vision system having at least one camera and via a controller operatively connected to the camera. The method may further include retrieving the first component with a first robot based on the determined location, and placing the first component on a support without fixtures using the first robot. The location of the first component on the support and the location of a second component are then determined via the same or a different vision system and the controller. The method then includes positioning the second component relative to the first component using the first robot or a second robot and based on the determined location of the first component on the support. The first component is then held relative to the second component according to said positioning via a fixtureless process joint. The positioning may include providing an appropriate standoff distance (i.e. gap) between the components in order to enable a subsequent laser welding process. For example, laser welding of zinc coated steels may have improved quality with reduced porosity when the materials have a standoff distance of around 0.3 mm between them in the area of the weld. This standoff distance may improve weld quality by allowing welding gasses to escape from the welded area prior to solidification. In some cases, the standoff distance should be minimized. For example laser welding of aluminum to aluminum should be done with a standoff distance less than about 0.125 mm in the area of the weld.

In an embodiment, the holding is by joining the first component to the second component with a process joint of a first predetermined strength, and after said joining, welding the first component to the second component with a structural joint of a second predetermined strength greater than the first predetermined strength. The positioning of the second component relative to the first component is maintained without fixtures and only by the process joint during said welding.

In an embodiment, the positioning is via one robot (i.e., a first robot), and welding of the first component to the second component is by an additional robot (i.e., a second robot) while the first robot maintains the positioning.

Under the method, holding the first component relative to the second component may include maintaining a predetermined force of the second component against the first component.

A system for assembling a first component and a second component using a releasable adhesive system for joining the first component with the second component, comprises a primary material having (i) a first portion configured to be positioned in contact with a first surface of the first component, and (ii) a second portion, opposite the first portion, that is configured to be positioned in contact with a second surface of the second component. The first portion of the primary material positioned in contact with the portion of the first surface is configured to (i) maintain a bond with the first surface of the first component up to a first predetermined shear force being exerted on the first surface, (ii) maintain a bond with the first surface of the first component up to a first predetermined pull force being exerted on the first surface, and (iii) release the bond with the first surface of the first component in response to at least a first predetermined peel force being exerted on the first surface.

In an embodiment, the second portion of the primary material is positioned in contact with the second surface of the second component and is configured to (i) maintain a bond with the second surface of the second component up to a second predetermined shear force being exerted on the second surface, (ii) maintain a bond with the second surface of the second component up to a second predetermined pull force being exerted on the second surface, and (iii) release the bond with the second surface of the second component in response to at least a second predetermined peel force exerted on the second surface.

In an embodiment a system for assembling a first component and a second component comprises a support configured to support a first component without any fixtures. The first component includes a first fastening feature. The system includes a locating system that determines a location of the first component when supported by the support and determines a location of a second component relative to the first component. The second component includes a second fastening feature. The system includes a robotic system that moves and positions the second component relative to the first component. The system includes a controller in communication with the locating system and the robotic system to operate the robotic system which positions the second fastening feature of the second component relative to the first fastening feature of the first component based on the locations determined by the locating system. The first and second fastening features engage each other to secure the first and second components together to create a process joint having a predetermined strength that holds the second component relative to the first component. The system may have a plurality of the first fastening features and a plurality of the second fastening features.

In an embodiment, the first fastening feature and the second fastening feature engage each other to establish a standoff distance between the first component and the second component. The standoff distance correlates with the placement of a subsequent structural weld that affixes the first and second components together.

In an embodiment, one of the first and second fastening features includes a tab and the other one of the first and second fastening features defines an aperture. The tab is disposed in the aperture to create the process joint. The first fastening feature and the second fastening feature may engage each other to establish a standoff distance between the first component and the second component, and at least one of the tab and one of the first and second fastening features adjacent to the aperture includes an extension to limit the distance the tab is inserted into the aperture to establish the standoff distance.

In an embodiment, one of the first and second fastening features includes a protrusion and the other one of the first and second fastening features defines an opening. The protrusion is disposed in the opening to create the process joint. The first fastening feature and the second fastening feature engage each other to establish a standoff distance between the first component and the second component. At least one of the first and second components includes an extension to limit the distance the protrusion is inserted into the opening to establish the standoff distance.

In an embodiment, the second fastening feature includes a retention member defining the opening, with the retention member being flexible such that the protrusion deforms the retention member when engaging each other.

In an embodiment, the first fastening feature and the second fastening feature engage each other to establish a standoff distance between the first component and the second component. The protrusion includes an outer periphery defining a groove, with the retention member engaging the groove to limit the distance the protrusion is inserted into the opening of the retention member to establish the standoff distance.

In an embodiment, the first fastening feature includes a first tab and the second fastening feature includes a second tab, with the first and second tabs engaging each other to create the process joint. For example, the first fastening feature and the second fastening feature may engage each other to establish a standoff distance between the first component and the second component. At least one of the first and second tabs may include an extension to limit the distance the first and second tabs engage each other to establish the standoff distance.

In an embodiment, one of the first and second fastening features includes a first projection and the other one of the first and second fastening features includes a second projection defining a hollow, with the first projection disposed in the hollow of the second projection to create the process joint. For example, the first fastening feature and the second fastening feature may engage each other to establish a standoff distance between the first component and the second component, and at least one of the first and second projections may be tapered to limit the distance the first projection is inserted into the hollow to establish the standoff distance.

In an embodiment, the locating system may include a vision system to locate the first component. The vision system may include a camera that observes the first component to identify the location of the first component. The camera may observe the second component to identify the location of the second component.

A method of assembling a first component and a second component comprises placing a first component on a support without fixtures using a robot, with the first component including a first fastening feature, determining the location of the first component when on the support via a locating system, and determining the location of a second component via the locating system, with the second component including a second fastening feature. The method further comprises positioning the second component relative to the first component using the robot based on the determined location of the first component on the support via the locating system, and engaging together the first fastening feature of the first component and the second fastening feature of the second component according to the positioning of the second component relative to the first component based on the locations determined by the locating system to create a process joint having a first predetermined strength that holds the second component relative to the first component.

In an embodiment, the method further comprises welding the first component and the second component together to create a structural joint after creating the process joint, with the structural joint having a second predetermined strength greater than the first predetermined strength. The relative position of the first component and the second component are maintained without fixtures by the process joint during welding of the first component and the second component to one another.

In an embodiment, engaging together the first fastening feature of the first component and the second fastening feature of the second component further comprises inserting a tab into an aperture to create the process joint.

In an embodiment, engaging together the first fastening feature of the first component and the second fastening feature of the second component further comprises inserting a protrusion into an opening to create the process joint. For example, inserting the protrusion into the opening to create the process joint further comprises inserting the protrusion into a retention member defining the opening. The method may further comprise deforming the retention member as the protrusion is inserted into the opening.

In an embodiment, engaging together the first fastening feature of the first component and the second fastening feature of the second component further comprises engaging together a first tab and a second tab to create the process joint.

In an embodiment, engaging together the first fastening feature of the first component and the second fastening feature of the second component further comprises inserting a first projection into a hollow of a second projection to create the process joint.

In an embodiment, engaging together the first fastening feature of the first component and the second fastening feature of the second component further comprises engaging together a plurality of first fastening features with respective second fastening features.

A system for assembling a first component and a second component comprises a support configured to support the first component without any fixtures. The assembly system also comprises a locating system that determines a location of the first component when supported by the support and determines a location of a second component relative to the first component. The assembly system further includes a robotic system that moves and positions the second component relative to the first component, and an applicator system that applies an adhesive to at least one of the first component and the second component. The assembly system includes a controller in communication with the locating system and the robotic system to operate the robotic system which positions the second component relative to the first component based on the locations determined by the locating system to adhere the first and second components together to create a process joint having a predetermined strength that holds the second component relative to the first component.

In an embodiment, the adhesive has a thickness establishing a standoff distance between the first component and the second component. The standoff distance correlates with the placement of a subsequent structural weld that affixes the first and second components together.

In an embodiment, the adhesive is applied to the second component, and the second component is adhered to the first component such that the adhesive is positioned between the first component and the second component to create the process joint.

In an embodiment, the first and second components are positioned relative to each other and the adhesive is applied to an edge of the second component which causes the adhesive to wick between the first and second components to create the process joint.

In an embodiment, the process joint is cured from about 1.0 seconds to about 50.0 seconds after adhering together the first and second components. The system may further include an accelerator applied to the process joint to decrease the time to cure the process joint.

In an embodiment, the locating system includes a vision system to locate the first component, and the vision system may include a camera that observes the first component to identify the location of the first component. The camera observes the second component to identify the location of the second component.

In an embodiment, the robotic system includes a force sensor in communication with the controller to measure an amount of force applied to at least one of the first component and the second component when adhering the first and second components together.

A method of assembling a first component and a second component comprises placing the first component on a support without fixtures using a robot, determining the location of the first component when on the support via a locating system, and determining the location of the second component via the locating system. The method further includes applying adhesive to at least one of the first component and the second component, and positioning the second component relative to the first component using the robot based on the determined location of the first component on the support via the locating system. The method further includes adhering together the first component and the second component according to the positioning of the second component relative to the first component based on the locations determined by the locating system to create a process joint having a first predetermined strength that holds the second component relative to the first component.

In an embodiment, the method further comprises welding the first component and the second component together to create a structural joint after creating the process joint, with the structural joint having a second predetermined strength greater than the first predetermined strength. The relative positions of the first component and the second component are maintained without fixtures by the process joint during welding the first component and the second component together.

In an embodiment, applying adhesive to at least one of the first component and the second component further comprises applying adhesive to an edge of the second component which causes the adhesive to wick between the first and second components to create the process joint.

In an embodiment, the method further comprises curing the process joint from about 1.0 seconds to about 50.0 seconds after adhering together the first and second components. The method may further comprise applying an accelerator to the process joint to decrease the time to cure the process joint.

The method may further comprise measuring an amount of force applied to at least one of the first component and the second component when adhering the first and second components together via a force sensor.

A system for assembling a first component and a second component comprises a fixtureless support configured to operatively support the first component without any fixtures. The system includes a locating system configured to determine a location of the first component and return a first component location result and determine a location of a second component and return a second component location result. The system includes a robotic system configured to pick and move the second component and further configured to position the second component relative to the first component. The system includes an applicator system that dispenses binder-coated particles and applies the binder-coated particles to at least one of the first component and the second component. The system includes a controller in communication with each of the locating system, the robotic system, and the applicator system. The controller has a processor and tangible, non-transitory memory on which is recorded instructions for coupling the first component and the second component based on the first component location result and the second component location result to form a process joint, such that the binder-coated particles are disposed between the first component and the second component at the process joint. The binder-coated particles establish a standoff distance between the first component and the second component, such that the standoff distance correlates with the placement of a subsequent welded structural joint that rigidly affixes the first component and the second component.

The system may be configured so that the process joint has a first predetermined strength that maintains the second component relative to the first component, and the welded structural joint has a second predetermined strength that is greater than the first predetermined strength.

In an embodiment of the system, the first component has a first process joint interface and the second component has a second process joint interface. The process joint is formed when the robotic system couples the first component with the second component at the first process joint interface and the second process joint interface, such that the coupling of the first component with the second component causes the binder-coated particles to be in contact with each of the first process joint interface and the second process joint interface.

In an embodiment of the system, the applicator system applies a single layer of the binder-coated particles to one of the first process joint interface and the second process joint interface, and the single layer of binder-coated particles has a thickness that establishes a standoff distance required for laser welding, such that the single layer of binder-coated particles couples the first component and the second component and the thickness thereof maintains the required standoff distance.

In an embodiment of the system, the applicator system applies at least one layer of binder-coated particles to each of the first component at the first process joint interface and the second component at the second process joint interface. The applicator system may apply a first layer of binder-coated particles and a second layer of binder-coated particles to each of the first process joint interface and the second process joint interface, such that the binder-coated particles of the second layer are intermittently placed atop and between the binder-coated particles of the first layer.

In an embodiment of the system, the binder-coated particles of the first layer and the second layer are applied so as to define a plurality of particle cavities along one of the first process joint interface and the second process joint interface. The binder-coated particles of the first layer and the second layer are applied so as to define a plurality of particle posts along the other of the first process joint interface and the second process joint interface, such that when the first process joint interface and second process joint interface are coupled to form the process joint, each particle cavity is configured to receive one of the plurality of particle posts forming an integration therebetween.

In an embodiment of the system, the integration of the plurality of particle cavities and the plurality of particles posts couples the first component and the second component while aligning the at least one second component relative to the first component. The integration of the plurality of particle cavities and the plurality of particles posts maintains a required standoff distance for laser welding.

In an embodiment of the system, the first process joint interface defines a plurality of trenches therealong. The applicator system may apply at least a first layer and a second layer of binder-coated particles to the second process joint interface. The binder-coated particles of the first layer may be intermittently spaced on the second process joint interface and the particles of the second layer may be placed intermittently and directly atop the particles of the first layer, such that the first layer and second layer form a plurality of binder-coated particle columns spaced apart from one another along the second process joint interface.

In an embodiment of the system, each of the respective trenches defined by the first process joint interface are configured to receive one of the plurality of columns formed by the binder-coated particles applied to the second process joint interface creating a connection therebetween, such that the connection of the plurality of trenches and the plurality of columns couples the first component and the second component and maintains a required standoff distance for laser welding.

In an embodiment of the system, the locating system includes at least one camera that observes the first component to determine the location of the first component, and the at least one camera also observes the second component to determine the location of the second component. The at least one camera may return a first component location result to the controller and a second component location result to the controller.

In an embodiment of the system, the robotic system includes a force sensor in communication with the controller to measure an amount of force applied to at least one of the first component and the second component when the first component and the second component are coupled.

In an embodiment of the system, the first component and the second component are composed of zinc coated steel, and the standoff distance is about 0.3 millimeters.

A method of assembling a first component and a second component comprises signaling, via a controller, a locating system to determine the location of a first component on a fixtureless support and to return a first component location result to the controller. The method further includes signaling, via the controller, the locating system to determine the location of the second component and to return a second component location result to the controller. The method includes commanding, via the controller, an applicator system to apply binder-coated particles to at least one of the first component at a first process joint interface and the second component at a second process joint interface, and commanding, via the controller, a robotic system to position the second component relative to the first component based on the first component location result returned by the locating system. The method further includes commanding, via the controller, the robotic system to couple the first component and the second component at the first process joint interface and the second process joint interface to create a process joint having a first predetermined strength that maintains the second component relative to the first component.

In an embodiment, the method further includes commanding, via the controller, a welding apparatus to weld the first component to the second component at the process joint to form a structural joint of a second predetermined strength, which is greater than the first predetermined strength. The first component and the second component are maintained relative to one another without fixtures and only by the process joint during the formation of the structural joint.

In an embodiment, commanding the applicator system to apply the binder-coated particles to at least one of the first component at a first process joint interface and the second component at a second process joint interface further includes applying, with the applicator system, a single layer of binder-coated particles, having a defined thickness, to one of the first process joint interface and the second process joint interface, such that the single layer of binder-coated particles couples the first component and the second component and the thickness of the single layer of binder-coated particles maintains a required standoff distance for laser welding.

In an embodiment, commanding the applicator system to apply binder-coated particles to at least one of the first component at a first process joint interface and the second component at a second process joint interface further includes applying, with the applicator system, a first layer of binder-coated particles and a second layer of binder-coated particles to each of the first process joint interface and the second process joint interface, such that the binder-coated particles of the second layer are intermittently placed atop and between the binder-coated particles of the first layer so as to define a plurality of particle cavities along one of the first process joint interface and the second process joint interface and so as to define a plurality of particle posts along the other of the first process joint interface and the second process joint interface. The first component and second component are coupled to form the process joint, each of the plurality of particle cavities is configured to receive one of the plurality of particle posts forming an integration therebetween, such that the integration of the plurality of particle cavities and the plurality of particles posts couples the first component and the second component and maintains the required standoff distance for laser welding.

In an embodiment, commanding the applicator system to apply binder-coated particles to at least one of the first component at a first process joint interface and the second component at a second process joint interface further includes applying, with the applicator system, at least a first layer and a second layer of binder-coated particles to the second process joint interface. The particles of the first layer are intermittently spaced on the second process joint interface and the particles of the second layer are placed intermittently and directly atop the particles of the first layer, such that the first layer and second layer form a plurality of columns spaced apart from one another along the second process joint interface. The first process joint interface defines a plurality of trenches therealong, such that each of the respective trenches defined by the first process joint interface are configured to receive one of the plurality of columns formed by the binder-coated particles applied to the second process joint interface forming a connection therebetween, such that the connection of the plurality of trenches and the plurality of columns couples the first component and the second component while aligning the second component relative to the first component. The connection of the plurality of particle columns and the plurality of trenches maintains a required standoff distance for laser welding.

A system for assembling a first component and a second component comprises a support operatively supporting the first component without any fixtures, a robotic system configured to hold the second component in a position relative to the first component, a controller operatively connected to the robotic system and operable to control the robotic system to position the second component relative to the first component, and a welder configured to weld the first and second components to one another when the second component is held in the position.

In an embodiment of the system for assembling the first component and the second component, the position of the second component relative to the first component establishes a standoff distance between the components. The standoff distance is correlated with a subsequent laser weld of the first component to the second component by the welder.

In an embodiment of the system for assembling the first component and the second component, the robotic system has a force sensor. The controller controls the robotic system to establish a predetermined holding force of the second component against the first component.

In an embodiment of the system for assembling the first component and the second component, the robotic system includes a first robotic arm operatively holding the second component in the location determined by the vision system to establish the process joint, and a second robotic arm configured to weld the first component to the second component with the welder while the first robotic arm holds the second component in the location determined by the vision system.

In an embodiment, the support may be another robotic arm or a repositionable support. The welder may be integrated in an end effector of a robot arm that also holds the second component. In an embodiment of the system for assembling the first component and the second component, a vision system is configured to view the supported first component and the second component and determine locations thereof. The controller is operatively connected to the vision system and further controls the robotic system based on the locations determined by the vision system.

A method of assembling a first component and a second component comprises placing a first component on a support without fixtures via a first robot, determining the location of the first component on the support and the location of the second component, and positioning the second component relative to the first component using the first robot or a second robot and based on the determined location of the first component on the support. The method further includes holding the second component relative to the first component according to the positioning to establish a process joint, and welding the first component to the second component during the holding of the second component relative to the first component. The relative positions of the first component and the second component are maintained without fixtures during said welding.

In an embodiment, the holding of the second component relative to the first component is via one robot, and the welding of the first component to the second component during the holding is via an additional robot.

In an embodiment, the holding of the second component relative to the first component and the welding of the first component to the second component during the holding are via a single robot.

In an embodiment, the holding of the second component relative to the first component includes maintaining a predetermined force of the second component against the first component.

The systems and methods set forth herein may reduce production costs and lead time, such as to introduce new products including the components, such as new vehicle models where the components are vehicle body components. Production costs and lead time may be reduced because dedicated fixtures and clamps for different stages of the assembly are not required. Complex part holding pallets and fixtures are not required as the vision system enables retrieval and placement of components without requiring their precise initial placement. Additionally, because many of the fixtureless supports and end effectors disclosed herein are reconfigurable, flexible and rapid reconfiguration for use with different subassemblies is enabled.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustration of an assembly of vehicle body components in exploded view.

FIG. 2 is a schematic perspective illustration of the assembly of FIG. 1.

FIG. 3 is a flow diagram of a method of assembling vehicle body components.

FIG. 4 is a schematic illustration of a body shop assembly system utilizing the method of FIG. 3.

FIG. 5 is a schematic illustration of a robot retrieving the first vehicle body component based on information from a vision system.

FIG. 6 is a schematic illustration of a portion of the system of FIG. 4, including a fixtureless support, a vision system, and a robotic system, as included in the system of FIG. 4.

FIG. 7 is a schematic illustration in partial cross-sectional view of a first embodiment of a reconfigurable fixtureless support shown supporting the first vehicle body component.

FIG. 8 is a schematic illustration in partial cross-sectional view of a second embodiment of a reconfigurable fixtureless support shown supporting the first vehicle body component.

FIG. 9 is a schematic illustration in partial cross-sectional view of a third embodiment of a reconfigurable fixtureless support shown supporting the first vehicle body component.

FIG. 10 is a schematic illustration in partial cross-sectional view of a fourth embodiment of a rapidly manufacturable fixtureless support shown supporting the first vehicle body component.

FIG. 11 is a schematic illustration in perspective view of a fifth embodiment of a reconfigurable fixtureless support shown supporting the first vehicle body component.

FIG. 12 is a schematic illustration in perspective view of a fixtureless bin holding some of the second vehicle body components.

FIG. 13 is a schematic illustration in fragmentary exploded view of the first and second vehicle body components having a mechanical process joint.

FIG. 14 is a schematic illustration in fragmentary cross-sectional view of the first and second vehicle body components joined at the mechanical process joint.

FIG. 15 is a schematic illustration in fragmentary cross-sectional view of the first and second vehicle body components having an adhesive process joint.

FIG. 16 is a schematic illustration in fragmentary cross-sectional view of the first and second vehicle body components having a process joint established by a layer of binder-coated particles.

FIG. 17 is a schematic fragmentary side view illustration of a robotically established process joint and showing cooperative remote laser welding.

FIG. 18 is a schematic fragmentary side view illustration of a first fastening feature and a second fastening feature of an embodiment spaced from each other.

FIG. 19 is a schematic fragmentary side view illustration of the first and second fastening features of the embodiment of FIG. 18 engaging each other.

FIG. 20 is a schematic fragmentary side view illustration of the first and second fastening features of FIGS. 18-19.

FIG. 21 is a schematic fragmentary side view illustration of a first fastening feature and a second fastening feature of another embodiment spaced from each other.

FIG. 22 is a schematic fragmentary side view illustration of the first and second fastening features of the embodiment of FIG. 21 engaging each other.

FIG. 23 is a schematic perspective view of a first fastening feature and a second fastening feature of yet another embodiment spaced from each other.

FIG. 24 is a schematic illustration of the first and second fastening features of the embodiment of FIG. 23 spaced from each other.

FIG. 25 is a schematic illustration of the first and second fastening features of the embodiment of FIGS. 23-24 engaging each other.

FIG. 26 is a schematic side view of the first and second fastening features of the embodiment of FIGS. 23-25 engaging each other.

FIG. 27 is a schematic illustration of a first fastening feature and a second fastening feature of another embodiment.

FIG. 28 is a schematic illustration of the first and second fastening features of the embodiment of FIG. 27 engaging each other.

FIG. 29 is a schematic exploded perspective view of the first and second body components.

FIG. 30 is a schematic fragmentary, cross-sectional view of the first and second body components structurally joined together.

FIG. 31 is a schematic flow diagram of a method of assembling a plurality of body components.

FIG. 32 is a schematic perspective view of adhesive applied to the first body component.

FIG. 33 is a schematic fragmentary cross-sectional view of the first and second body components having an adhesive creating a process joint therebetween.

FIG. 34 is a schematic fragmentary cross-sectional view of adhesive applied to the second body component.

FIG. 35 is a schematic fragmentary side view of the first and second body components, with adhesive applied to an edge of the second body component.

FIG. 36 is a schematic fragmentary cross-sectional view of the first and second body components with the process joint creating the standoff distance.

FIG. 37 is a schematic flow diagram of a method of assembling a plurality of body components.

FIG. 38 is a schematic illustration of an assembly system, including a fixtureless support, a locating system, a robotic system, and an applicator system, as included in the body shop system of FIG. 4.

FIG. 39 is a first schematic illustration of binder-coated particles applied in a single layer to at least one of the first component and the second body component.

FIG. 40 is a schematic illustration in a fragmentary cross-sectional view of the first component and the second component having binder-coated particles therebetween as applied in FIG. 39.

FIG. 41 a schematic illustration in a fragmentary cross-sectional view of the first component and the second component having binder-coated particles therebetween, as applied in FIG. 39, such that the thickness of the single layer of binder-coated particles maintains the required standoff distance for laser welding.

FIG. 42 is a second schematic illustration of binder-coated particles applied in multiple layers to each of the first component and second body component.

FIG. 43 is a schematic illustration in a fragmentary cross-sectional view of the first component and the second component having binder-coated particles therebetween as applied in FIG. 42.

FIG. 44 is a schematic illustration in a fragmentary cross-sectional view of the first component and the second component having binder-coated particles therebetween, as applied in FIG. 42, such that the integration of the layers of binder-coated particles applied to the first component and the layers of binder-coated particles applied to the second component maintains the required standoff distance for laser welding.

FIG. 45 is a third schematic illustration of binder-coated particles applied in multiple layers to each of the second component in association with a first component defining a plurality of trenches along its first process joint interface.

FIG. 46 is a schematic illustration in a fragmentary cross-sectional view of the first component and the second component having binder-coated particles therebetween as applied in FIG. 45.

FIG. 47 is a schematic illustration in a fragmentary cross-sectional view of the first component and the second component having binder-coated particles therebetween, as applied in FIG. 45, such that the connection of the layers of binder-coated particles applied to the second component and the plurality of trenches defined by the first component maintains the required standoff distance for laser welding.

FIG. 48 is flow diagram detailing the steps of the present method of assembling a plurality of body components.

FIG. 49 is a flow diagram of a method of assembling vehicle body components.

FIG. 50 is a schematic illustration in side view of a portion of a system including a fixtureless support, a vision system, and a robotic system to establish a process joint and enabling cooperative welding.

FIG. 51 is a schematic illustration in side view of an embodiment of a system using a reconfigurable fixtureless support and a robotic arm with a reconfigurable end effector to establish a process joint and enabling cooperative resistance spot welding.

FIG. 52 is a schematic illustration in side view of an embodiment of a system using a reconfigurable fixtureless support and a robotic arm with a reconfigurable end effector to establish a process joint, and having a welding head integrated in the end effector to enable cooperative laser welding.

FIG. 53 illustrates a side view of a removable adhesive in accordance with an embodiment of the present technology.

FIG. 54 is a perspective view of an alternative embodiment of the removable adhesive of FIG. 53.

FIG. 55 is a side view of a second alternative embodiment of the removable adhesive of FIG. 53.

FIG. 56 is a perspective view of a third alternative embodiment of the removable adhesive of FIG. 53.

FIG. 57 is a schematic illustration in plan view of a tape dispenser for applying the releasable adhesive of FIG. 53.

FIG. 58 is a schematic illustration in perspective view of a process for securing first and second components to one another using the tape dispenser of FIG. 57 in a fixtureless application.

FIG. 59 is a schematic illustration in perspective view further illustrating the process of FIG. 58.

### DETAILED DESCRIPTION

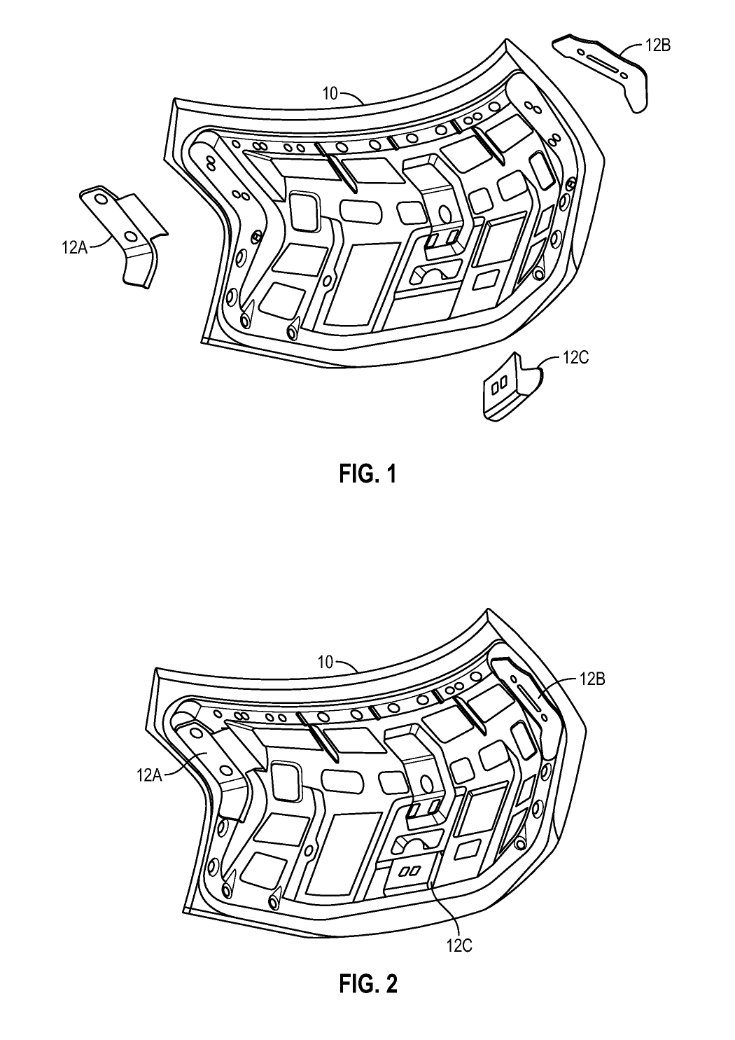

Referring to the drawings, wherein like reference numbers refer to like components throughout the views, FIG. 1 shows an exploded view of a first component 10, and multiple second components 12A, 12B, 12C. In the embodiment shown, the first component 10 is a first vehicle body component 10, and may be referred to as such. More specifically, the first vehicle body component 10 is a deck lid inner panel. The second components 12A, 12B, 12C are reinforcement components for the first vehicle body component 10, and may be referred to as second vehicle body components. The reference numeral 12 may also be used in reference to any of the second vehicle components 12A, 12B, 12C. FIG. 2 shows the first component 10 and the second components 12A, 12B, 12C after completed assembly. As discussed herein, the assembly of the first vehicle component 10 and the second vehicle components 12A, 12B, 12C is accomplished without the use of dedicated fixtures to present, position, or hold the components 10, 12A, 12B, 12C. Instead, one or more vision-guided robots place the components in positions relative to one another. As such, precision geometry setting of the exact locations of each of the components to be assembled to one another is not required, because the vision system is able to inform the robots of relative component locations during operation of the robots.

Once the components are located relative to one another, a process joint is established to hold the components in the relative positions (including standoff distance between materials) until a structural joint is created in a subsequent processing operation. The process joint may be accomplished with mechanical features, mechanical joining methods, fusion bonding methods, solid state bonding methods, adhesive, a holding force provided by one or more robots, or otherwise. In other words, clamps are not needed or used, as they are replaced by one or more process joints. The process joint has a first strength, and the structural joint has a greater second strength. The structural joint may be a laser weld, resistance spot weld, other fusion weld (e.g. mig weld), solid state bond (e.g. ultrasonic weld or friction stir weld), mechanical joint (e.g. rivet, flow drill screw), structural adhesive, or hybrid method of the above which is configured to hold the first and second components to one another throughout the useful life of the assembly when installed on a vehicle. The process joint may provide a predetermined standoff distance if laser welding is used for the structural joint. For example, laser welding of zinc coated steels may have improved quality with reduced porosity when the materials have a standoff distance of about 0.3 mm between them in the area of the weld. This standoff distance may improve weld quality by allowing welding gasses to escape from the welded area prior to solidification. In some cases, the standoff distance should be minimized. For example laser welding of aluminum to aluminum should be done with a standoff distance less than about 0.125 mm in the area of the weld. A variety of modes for positioning the components and for creating the process joint are disclosed herein.

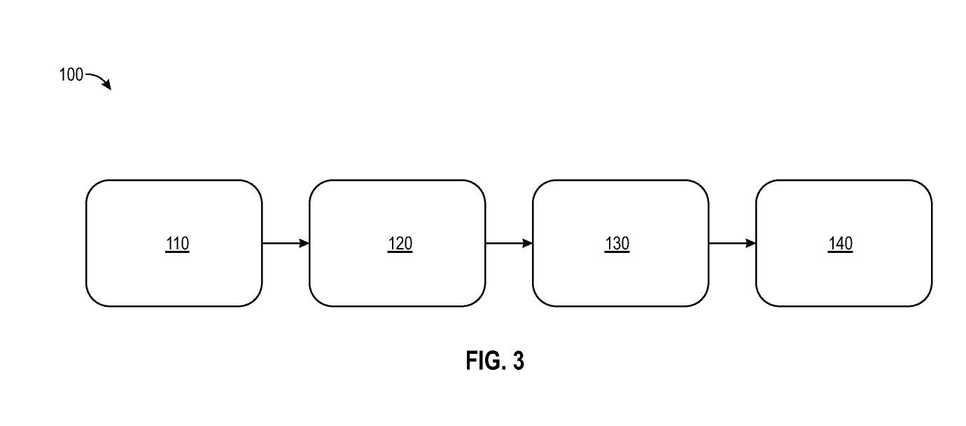

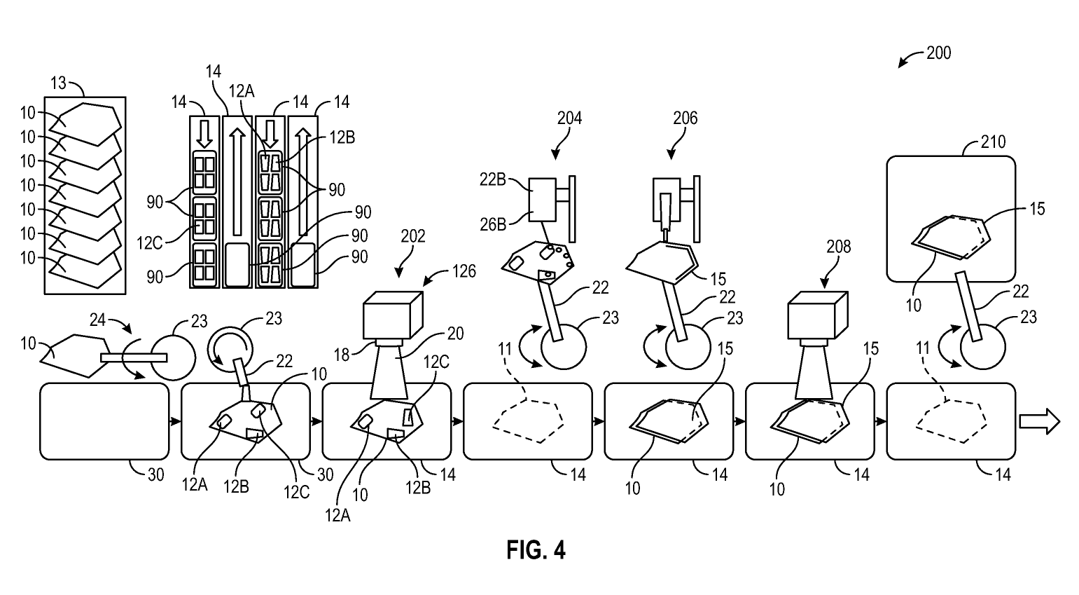

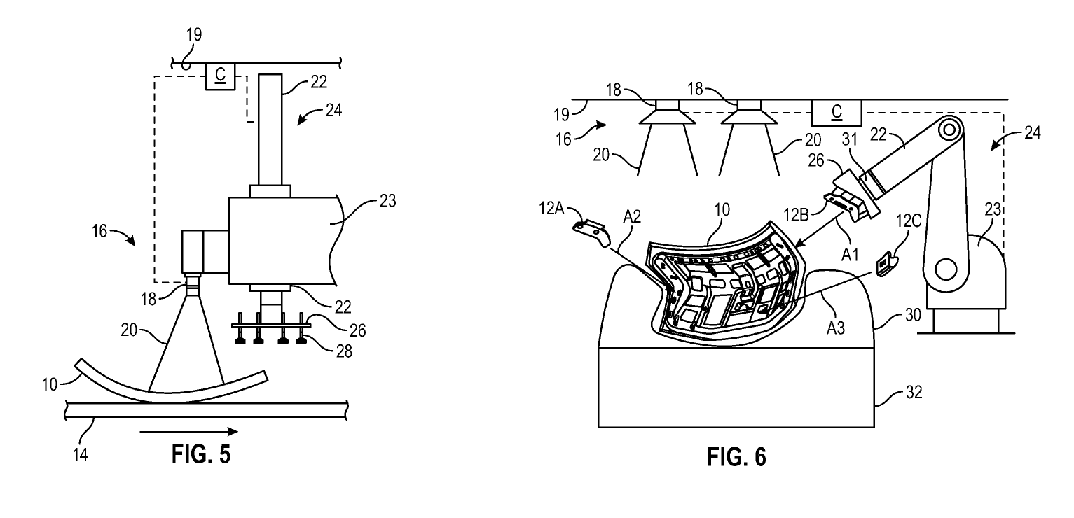

FIG. 3 shows a flow diagram of the method of assembly 100, and FIG. 4 shows one example of an assembly system 200 (illustrated as a body shop assembly system) utilizing the method 100 from component introduction to finish hemming. In FIG. 3, the method 100 includes block 110, in which a robot picks and places the first component 10 from an unfixtured initial support 13, such as a standard flat belt conveyor, a storage bin, or a shipping rack. The initial support 13 is shown as a shipping rack in FIG. 4. A plurality of similar first vehicle body components 10 are shown stacked in the initial support 13. Various ones of the first vehicle body components are shown at different stages of the method 100 in the system. A controller C (shown in FIG. 5) determines a location of the unfixtured first component 10 on the initial support 13 using any suitable locating system, such as a vision system 16 having at least one camera 18. Any one or more of various arrangements of vision systems 16 may be used for providing visual information to the controller C. In one example shown in FIG. 5, the vision system 16 includes a three-dimensional stationary camera 18 that provides light over a field of vision 20, creating a stripe of light (or other pattern) across the first component 10 as it passes under the camera 18 on a conveyor belt 14. In various embodiments, the light may be a laser beam. The camera 18 and controller C may be configured to locate various features such as holes or flanges of the component 10. Alternatively or in addition, the controller C may register the contours of the component 10 based on the various depths of the light on the surface of the component 10.

In some embodiments, multiple cameras 18 can be situated in fixed locations in the assembly cell, or may be mounted on the robotic arm 22. FIG. 6 shows two cameras 18 mounted adjacent one another on a frame 19 to provide stereo vision of the component 10 and component 12A, 12B, or 12C on the robotic arm 22. In any of the embodiments, the camera(s) 18 are operatively connected to a controller C that also controls one or more robots 23 of a robotic system 24. Based on the information received from the cameras 18, the controller C then provides a control signal that actuates robotic arm(s) 22 of the one or more robot(s) used in the method 100.

The controller C can include a processor and a memory on which is recorded instructions for communicating with the vision system 16, the robotic system 24, sensor(s), etc. The controller C is configured to execute the instructions from the memory, via the processor. For example, the controller C can be a host machine or distributed system, e.g., a computer such as a digital computer or microcomputer, acting as a vehicle control module having a processor, and, as the memory, tangible, non-transitory computer-readable memory such as read-only memory (ROM) or flash memory. The controller C can also have random access memory (RAM), electrically erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller C can include all software, hardware, memory, algorithms, connections, sensors, etc., necessary to monitor and control the vision system 16, the robotic system 24, etc. As such, a control method can be embodied as software or firmware associated with the controller C. It is to be appreciated that the controller C can also include any device capable of analyzing data from various sensors, comparing data, making the necessary decisions required to control and monitor the vision system 16, the robotic system 24, sensors, etc.

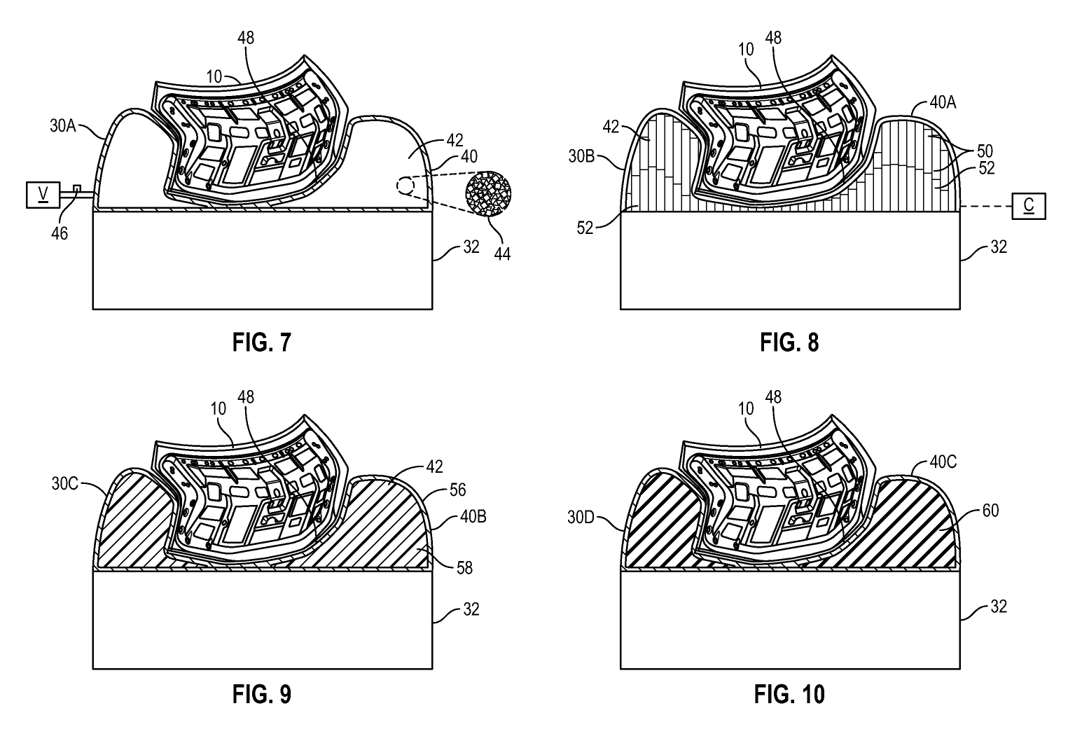

As shown in FIG. 5, an end effector 26 on the arm 22 may include a series of grippers 28 positioned to connect to the component 10. The robotic arm 22 is then actuated by the controller C to retrieve the component 10 with the end effector 26 from the conveyor belt 14, positioning the end effector 26 on the component 10 using the determined location from the visual position data of the vision system 16. The grippers 28 may include reconfigurable suction cups, sliding pins that move the suction cups relative to one another, a conformable material similar to that described with respect to FIG. 7, magnets, or the like. In FIG. 6, an end effector 26 holds component 12B to be positioned on component 10, as indicated by arrow Al. Components 12A, 12C are schematically shown for purposes of reference only, and would each be individually moved into position on the supported first component 10, as indicated by arrows A2 and A3, either by the same or a different robotic arm 22.

Other embodiments of end effectors that may be suitable for use include those disclosed in the following, each of which is incorporated by reference in its entirety: U.S. Pat. No. 8,684,418 to Lin et al.; U.S. Pat. No. 8,496,425 to Lin et al.; U.S. Pat. No. 8,371,631 to Lin; U.S. Pat. No. 8,087,845 to Lin et al.; U.S. Pat. No. 8,033,002 to Lin et al.; U.S. Pat. No. 8,025,277 to Lin et al.; U.S. Pat. No. 7,971,916 to Lin et al.; U.S. Patent Application Publication No. 20120280527 to Lin et al.; U.S. Patent Application Publication No. 20110182655 to Lin et al.; and U.S. Patent Application Publication No. 20110017007 to Lin et al.

Referring again to FIGS. 3 and 4, in block 120 of the method 100, the first component 10 is placed on a fixtureless support 30 by the robotic system 24, as shown in FIG. 6. The fixtureless support 30 may be referred to as a part rest, and is on a base 32. In one embodiment, the base 32 that may be a slow moving conveyor belt that moves between stations of the assembly system 200 of FIG. 4. Alternatively, the base 32 can be stationary, and the various robots 23 used can move toward the base 32 and the support 30 to accomplish the series of assembly steps. In various embodiments, the fixtureless support 30 may be a reconfigurable support, enabling its use for differently-configured body components during different assembly processes. In other embodiments, the fixtureless support may not be reconfigurable, but is of a relatively inexpensive material. In all embodiments, the fixtureless support 30 need only support the component 10 in a location that is relatively imprecise in comparison to an assembly system in which the robotic system used is “blind”. This is because, with the benefit of position information gleaned from the vision system 16, the robot 23 will be able to position the second vehicle body components 12A, 12B, or 12C relative to the first component 10.

FIG. 7 shows one embodiment of the fixtureless support 30 of FIG. 6, referred to with reference number 30A. The support 30A is a reconfigurable flexible container 40 defining a cavity 42 filled with granules 44, similar to a bean bag. The container 40 is a flexible liner of polymeric or other durable, smooth material. The granules 44 may be a variety of shapes, at least some of which may be nonspherical. A vacuum supply V is operatively placed in fluid communication with the cavity 42 when the controller C actuates an openable and closable valve 46 to open the valve 46. A sample first component 10 can be pressed against the container 40 while the vacuum V acts on the cavity 42 to remove air from the cavity 42. The granules 44 are pulled against one another and against the component 10 due to the vacuum V, and conform to the shape of the outer surface of the component 10. A recess 48 formed in the container 40 thus conforms to the component 10 sufficiently to support the component 10 for subsequent stages of the method 100. The support 30A thus offers mechanical flexibility and reconfigurability. For example, to reconfigure the support 30A, application of the vacuum V is removed and a vent valve (not shown) allows air to enter the cavity 42. The granules 44 and container 40 are then relaxed and can be reshaped to reconfigure the support 30A. The vacuum V can then be applied when a different component having a different shape or the same shape as component 10 is pressed against the flexible container 40.

FIG. 8 shows another embodiment of the fixtureless support 30 of FIG. 6, referred to with reference number 30B. The support 30B is a reconfigurable flexible container 40A. The container 40A is a flexible liner of polymeric or other durable, smooth material. A bed of rigid pins 50 is contained within a cavity 42 of the container 40A. The pins 50 are arranged parallel with one another. The bottom of each of the pins 50 can be fixed to a respective actuator 52 controlled by the controller to provide a predetermined height and/or force toward the component 10. The pins 50 may be telescopic, or may be of fixed length, with the actuators 52 extending as necessary. The actuators 52 may be electromagnetic, hydraulic, pneumatic, or any other suitable type of actuator. A sample component 10 can be placed on the container 40A. Once actuated, those pins 50 in alignment with a portion of the component 10 will experience reaction force due to the component 10, and will cease upward movement. In this manner, the container 40A will provide a recess 48 that conforms to the shape of the outer surface of the component 10. The pressure P can be maintained in order to sufficiently support the component 10 during subsequent stages of the method 100. Alternatively, the pins 50 can be locked into this position to maintain the shape using an appropriate shaft locking method (e.g. hydraulic lock, or mechanical wedge lock). This approach may be used when producing batches of assemblies with the same geometry. The support 30B thus offers mechanical flexibility and reconfigurability, as deactivation of the actuators 52 allows the pins 50 to slide or otherwise move to unactuated positions, and the container 40A can be reshaped for use with a differently shaped component.

FIG. 9 shows another embodiment of the fixtureless support 30 of FIG. 6, referred to with reference number 30C. The support 30C is a reconfigurable flexible container 40B. The container 40B can be a flexible liner of polymeric or other durable, smooth material. A cavity 42 of the container 40B is filled with a shape memory polymer 58. The shape memory polymer 58 could be coated with a durable material creating a coating as a liner 56. In some embodiments, the shape memory polymer may be durable enough so that it need not be placed in a container. When the shape memory polymer 58 is in a first, permanent (i.e., remembered) shape, a sample component 10 is pressed against the container 40B. The shape memory polymer 58 is then activated, such as by thermal activation by heating the polymer 58 above an activation temperature, to cause the shape memory polymer to take on a temporary shape that conforms to the outer surface of the component 10. A recess 48 conforms to the shape of the outer surface of the component 10. The temporary shape is shown in FIG. 9. The support 30C is then cooled to room temperature, causing the shape memory polymer to remain in the temporary shape until reactivated, such as by reheating above the activation temperature. The support 30C thus offers mechanical flexibility and reconfigurability, as reactivation allows the container 40B to be reshaped for use with a differently shaped component.

FIG. 10 shows another embodiment of the fixtureless support 30 of FIG. 6, referred to with reference number 30D. The support 30D has a solid plastic core 60 printed with a three-dimensional printer based on the dimensional specifications of the component 10. In other words, the core 60 is printed to provide a recess 48 conforming to the shape of the outer surface of the component 10. A liner such as a coated plastic surface 40C is applied to the core 60 for durability. The support 30D can be rapidly manufactured, and is relatively inexpensive in comparison to fixtured supports.

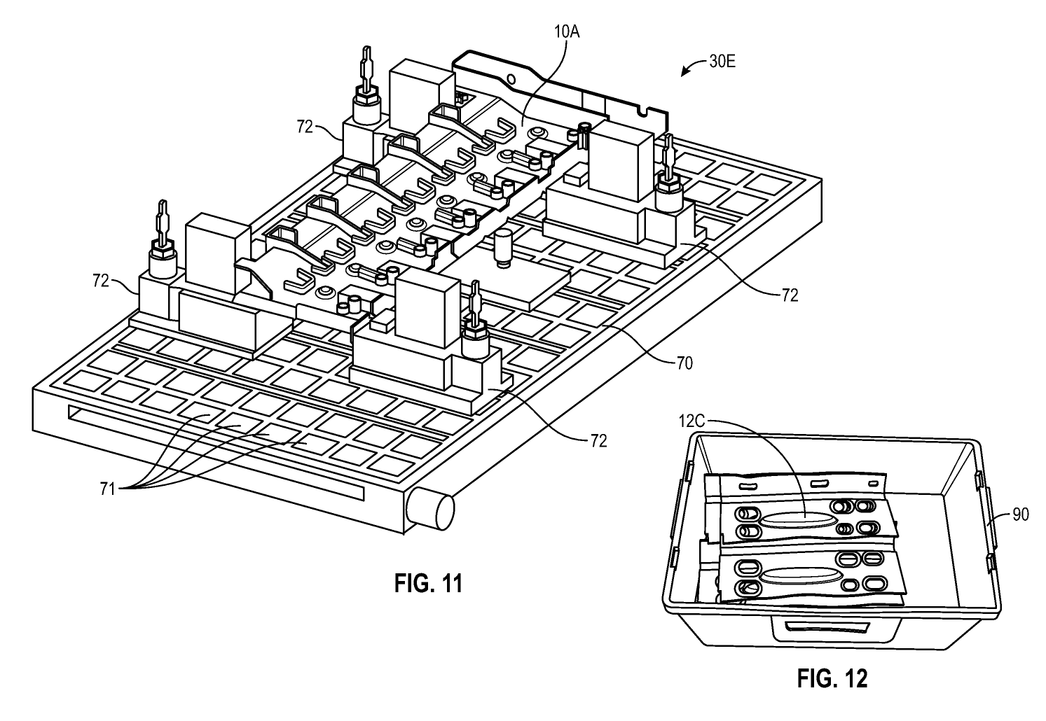

FIG. 11 shows an additional embodiment of the fixtureless support 30 of FIG. 6. In FIG. 11, the embodiment of the support 30 is referred to with reference number 30E. The support 30E has a magnetic base 70, also referred to as a magnetic chuck, that may include a plurality of magnetic members 71 to which a magnetic field can be selectively applied. When the field is off, magnetic multi-piece locating elements 72 can be reshaped and repositioned on the base 32 to provide support for a specifically shaped vehicle body component, such as component 10A. When the magnetic field is reapplied, the locating elements 72 are held fixed in position on the base 70 by the magnetic field.

In another embodiment, the support may have a base to which cooperatively configured interconnecting support members can be mounted. The support members can have a variety of shapes and sizes and can snap mount to the base and to one another in a variety of configurations to provide a desired configuration complementary to the shape of the vehicle body component 10 to support the component 10 in a location with a suitable degree of precision for subsequent location of the component 10 by a vision-based robotic system 24.

It should be appreciated that any of the embodiments of the supports 30A, 30B, 30C, 30D, 30E, can provide a lesser degree of precision in geometric placement of the supported component 10 than that required for visionless systems, because the vision system 16 can enable the robotic system 24 to locate the component 10 for assembly with the second vehicle components 12. Additionally, if the supports 30A, 30B, 30C, 30D, 30E are used to support the component 10 only during formation of the process joint, less precision is required than during formation of the subsequent structural joint.

Other embodiments of reconfigurable supports that may be suitable for use include those disclosed in the following, each of which is incorporated by reference in its entirety: U.S. Pat. No. 7,210,212 to Lin; U.S. Pat. No. 7,201,059 to Lin et al.; 7,055,679 to Shen et al.; U.S. Pat. No. 7,000,966 to Kramarczyk et al.; U.S. Pat. No. 6,877,729 to Lin et al.; U.S. Pat. No. 6,712,348 to Kramarczyk et al.; and U.S. Pat. No. 6,644,637 to Shen et al.

It should be appreciated that any of the concepts of the embodiments of the supports 30A, 30B, 30C, 30D, 30E can also be applied to enable a reconfigurable end effector on the robotic arm 22 to support the second component 12A, 12B, or 12C for positioning relative to the first component 10. For example, the flexible container 40 filled with granules 44 and conformable via a vacuum V may be scaled for connection to a robot end effector for gripping the second component 12A during positioning by the robotic arm 22.

Referring again to FIGS. 3 and 4, once the first component 10 is positioned on the support 30, block 120 continues by using the vision system 16 to determine the location of the first component 10 on the support and the location(s) of the second vehicle body component(s) 12A, 12B, 12C. The method 100 is designed so that the second vehicle body components 12A, 12B, 12C are those that are smaller in size than the first component 10. The second vehicle body components may be sufficiently small to be presented for assembly in fixtureless bins 90, as indicated in FIGS. 4 and 12. FIG. 4 shows the full bins 90 moving on conveyor belts 14 to the same or a different robot 23. The vision system 16 shown in greater detail in FIG. 6 aids the robot 23 in locating the second component 12A, 12B or 12C in the respective bin 90, and moving it adjacent to the first component 10 held in the support 30. The controller C processes the location information received from the vision system 16 and controls the robot arm 22 to position the second component 12A, 12B, or 12C, one at a time, relative to the first component 10.

The method 100 then proceeds to block 130 in which a process joint is provided to maintain a desired position of the second component 12A, 12B, or 12C relative to the first component 10. In other words, the process joint is the mechanism by which the components 10, and 12A, 12B, and/or 12C are held relative to one another prior to establishment of one or more final structural joints. The support 30 and the process joint thus serve as the geography setting features of the first component 10 and the second component 12A, 12B, or 12C prior to establishment of the structural joints.

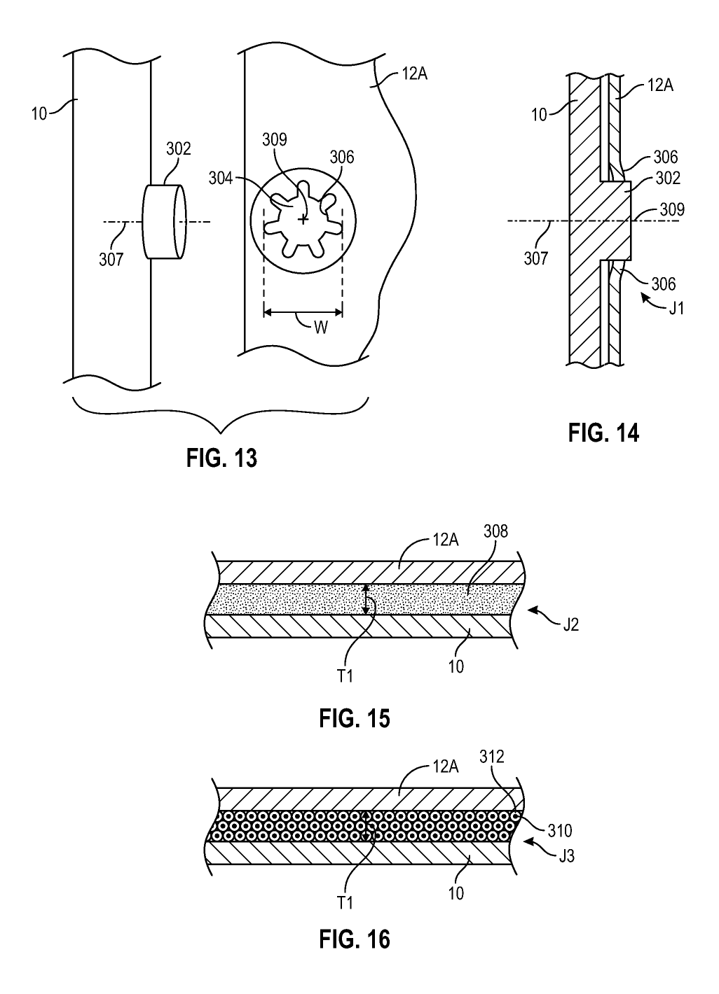

Many different embodiments of process joints may be provided within the scope of the method 100. FIG. 13 shows the first component 10 has a first feature 302, and the second component 12A has a second feature 304, 306 complementary to the first feature 302 such that the first feature 302 and the second feature 304, 306 press-fit to one another to establish a process joint J1, shown in FIG. 14. The first feature 302 is shown turned 90 degrees relative to the second feature 304, 306 from an inserted position in which the axes 307 and 309 are parallel, as shown in FIG. 14. The process joint J1 is configured with a predetermined strength sufficient to maintain the second vehicle component 12A relative to the first vehicle component 10 in the location determined by the vision system 16. Specifically, the first feature 302 is a protrusion and may be referred to as such, and the second feature is a multitude of flexible retention members 306 adjacent a recess 304 stamped into the second component 12A, and may be referred to as such. Multiple retention members 306 are configured as flexible tangs or tabs that elastically deform when the protrusion 302 is inserted into the recess 304 as the robotic arm 22 moves the second component 12A into the determined position relative to the first component 10, establishing a snap-fit process joint J1. The joint J1 may be configured to maintain the second vehicle component 12A at a predetermined standoff distance from the first component 10 as required for a subsequent laser welding operation, such as when laser welding is used to establish a structural joint as further discussed herein. The joint J1 eliminates the need for clamps to hold the components 10, 12A to one another during a subsequent laser welding or resistance spot welding operation. The components 12B, 12C can be configured with similar features 304, 306 to receive additional protrusions 302 of the first component 10. Alternatively, the first component 10 can be configured with the features 304, 306, and the components 12A, 12B, 12C can be configured with features 302.

The recess 304 with retention members 306 allows for some variation or play in the centering of the protrusion 302 relative to the recess 304. In other words, the protrusion 302 has a diameter slightly smaller than a maximum width W of the recess 304. When several protrusions 302 positioned at different locations on the component 10 are required to align with several recesses 34 with retention members 36 on the component 12A, the ability for the alignment of each respective pair of a protrusion 302 and a recess 304 to have some play enables the components 10, 12A to be fit to one another within the range of dimensional tolerances of the features 302, 304, 306. For example, if a center axis 307 of the protrusion 302 is slightly offset from the center axis 309 of the recess 304 elastic deformation of the retention members 306 circumferentially surrounding the axis 309 will tend to self-align the components 10, 12A to one another. The average of the elastic deformation between all of the pairs of protrusions 302 of the first vehicle body member 10 and retention features 306 of the second vehicle body member 12A aligns the first vehicle body member 10 relative to the second vehicle body member 12A.

FIG. 15 shows another embodiment of a process joint J2 established by adhesive 308 placed between the first component 10 and the second component 12A. The adhesive 308 may be preapplied to either of the components 10, 12A prior to relative positioning. The adhesive may be a quick-drying structural adhesive with a predetermined strength sufficient to maintain the second component 12A in the desired predetermined position until a subsequent structural joint is provided, such as by laser welding or resistance spot welding. The adhesive 308 may be configured to have a thickness T1 when dried that is sufficient to maintain the second vehicle component 12A a predetermined standoff distance T1 required for a subsequent laser welding operation, such as when laser welding is used to establish a structural joint as further discussed herein.

Additionally, the force of application of the second component 12A onto the first component 10 may be controlled by integrating a force sensor 31 at the end effector 26 on the robotic arm 22, as shown in FIG. 6. The force sensor 31 is operatively connected to the controller C and is controlled to ensure that the force applied by the end effector 26 to create the process joint remains below a predetermined threshold. For example, when adhesive 308 is used, the force sensor 31 may be controlled to ensure that a proper application force acts on the adhesive 308, but without causing deformation of the components 10, 12A. In all embodiments, if there is operative contact between the components 10, 12A during formation of the process joint, either direct contact or indirect through adhesive or otherwise, the controller C can control the robotic arm 22 to allow movement in a plane perpendicular to the force (e.g., in an X-Y plane if the force is in a Z direction), thereby allowing force control to take precedence over positional information when establishing the process joint. In this manner locating and holding of the components 10, 12A is integrated in a hybrid control of robot arm motion and force.

FIG. 16 shows another embodiment of a process joint J3 in which particles 310 with a binder coating 312 are placed between the first component 10 and the second component 12A. The layer of binder-coated particles 310 may be preapplied to either of the components 10, 12A prior to relative positioning, and may be configured to quickly set when the second component 12A is moved against the first component 10. Force control may be used via the force sensor 31 of FIG. 6. The binder-coated particles 310 may have a predetermined strength when set that is sufficient to maintain the second component 12A in the desired predetermined position until a subsequent structural joint is provided, such as by laser welding or resistance spot welding. The layer of binder-coated particles 310 may be configured to have a thickness T1 when cured that is sufficient to maintain the second vehicle component 12A at a predetermined standoff distance T1 required for a subsequent laser welding operation, such as when laser welding is used to establish a structural joint as further discussed herein.

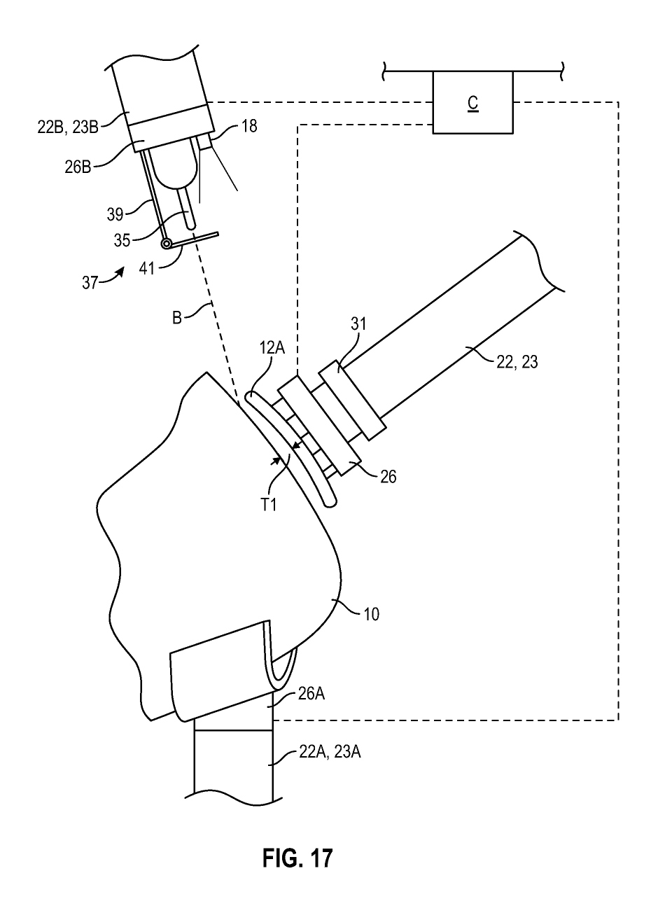

As an alternative to structural features of the components 10, 12A, or material such as adhesive or binder-coated particles, one or more robots can be controlled cooperatively to hold the second vehicle component 12A in a desired position relative to the first vehicle component 10 thereby establishing a process joint. In FIG. 17, a first robot 23 has a first robot arm 22 that has an end effector 26 that holds component 12A, and also has a force sensor 31 enabling hybrid force and position control. A second robot 23A has a second robot arm 22A that holds the first component 10. An end effector 26A of the second arm 22A may be one or more clamps. The robots 23, 23A thus provide a function similar to a traditional clamp used to hold the relative position of the components 10, 12A. The relative position may include a predetermined standoff distance T1 if laser welding is to be applied. Alternatively, an adjustable support that is not robotic could be used to support the component 10. A third robot 23B having a third robot arm 22B can be used to provide one or more welds to hold the components to one another. The third robot 23B is shown enabling remote laser welding, as a laser welding tool 35 and a 3D camera 18 are included in the end effector 26B. Additionally, a movable mirror system 37 can be included in the end effector 26B and controlled by the controller C to deflect the laser beam B as desired. The controller C thus remotely steers the laser beam B via the mirror system 37. The mirror system 37 has an actuator 39 that moves a mirror 41 relative to the beam B. In the position shown, the mirror 41 is offset from the beam B and is not deflecting the beam B. Rapid welds can be accomplished at different locations of an interface between the component 10 and the component 12A by moving the mirror system 37. The robotic arm 22B can then be moved to a new location relative to the components 10, 12A, and the mirror system 37 controlled to provide another series of remote laser welds of the components 10, 12A. Alternatively, the robotic arms 22, 22A could place the components 10, 12A in contact with one another, and the third robot 23B can be configured to provide resistance welding.

Welding can be accomplished by a robotically positioned “traditional” laser welding head which is different than a remote laser welding head. A traditional laser welding head will have “fixed” optics that only point in a single direction relative to the robot end effector. The “traditional” laser welder will also typically have optics that provide for a relatively short standoff distance (e.g. 100 mm) from the point of welding.

Welding may also be accomplished by a robotically positioned “remote” laser welding head where a laser beam and optics are inside of the head. The optics have a relatively long focal length that also includes a controllable mirror allowing the laser beam to be quickly re-aimed to different positions at distances of about 1 meter from the remote laser welding head. Many positions can be welded from a stationary robot position. Then the robot can reposition the remote laser welding head to new positions as needed to make welds in locations that were outside the field of view.

Still further, welding can be accomplished by one or more stationary (fixed) remote laser welders which are mounted on a fixed structure (not on a robot). Each remote laser welding head has a laser beam and optics having a relatively long focal length that also includes a controllable mirror allowing the laser beam to be quickly re- aimed to different positions at distances of about 1 meter or even more from the remote laser welding head. Since a remote laser welding head has a finite window of coverage (due to limitations on the angle of the mirror) (e.g. 1 sq. m window), additional heads are used as needed to ensure complete coverage of welds over the part surface.

With reference to FIGS. 3 and 4, after the process joint is established in block 130, the components 10, 12A, 12B, 12C are considered to be geometrically set in position relative to one another, and the method 100 proceeds to block 140. The assembly 10 can be removed from the support 30 and placed on a movable support such as a conveyor 14. In block 140, the final structural connections of the assembly are carried out, such as by welding with laser or resistance spot welds. FIG. 4 shows that the assembly with process joints may be inspected by scanning with a three-dimensional vision system 126 at a scanning station 202. The vision system 126 may be substantially similar to the vision system 16, and either may be used in the assembly system 200. If the positioning via the process joints is sufficient, the assembly can be moved by another robot 23 from the conveyor 14 to a remote laser welding station 204 where laser welding can be carried out with a remote laser welder having an end effector 26B with a vision system and mirror system as shown and described in FIG. 17. Where the component 10 has been moved off of the conveyor 14, an outline 11 is shown of the previous position of the component 10 on the conveyor 14.

After welding, the robot 23 returns the assembly to the conveyor 14. In an adhesive station 206, adhesive can be applied to another vehicle body component, such as a decklid outer panel 15, and a robot 23 moves the outer panel into position on the assembly of the inner panel 10 and structural components 12A, 12B, 12C. The robot 23, a vision system, and flexible end effector can be cooperatively controlled by the controller C to enable quick application of the adhesive. The adhered components 10, 15 can then be inspected at a scanning station 208 for conformance with predetermined positioning specifications inspected by scanning with a three-dimensional vision system 126 similar to that used at scanning station 202. If the positioning via the adhesive is sufficient, the assembly can be moved by another robot 23 from the conveyor 14 to one or more additional processing stations, such as a hemming press 210 for hemming the attached components 10, 15.

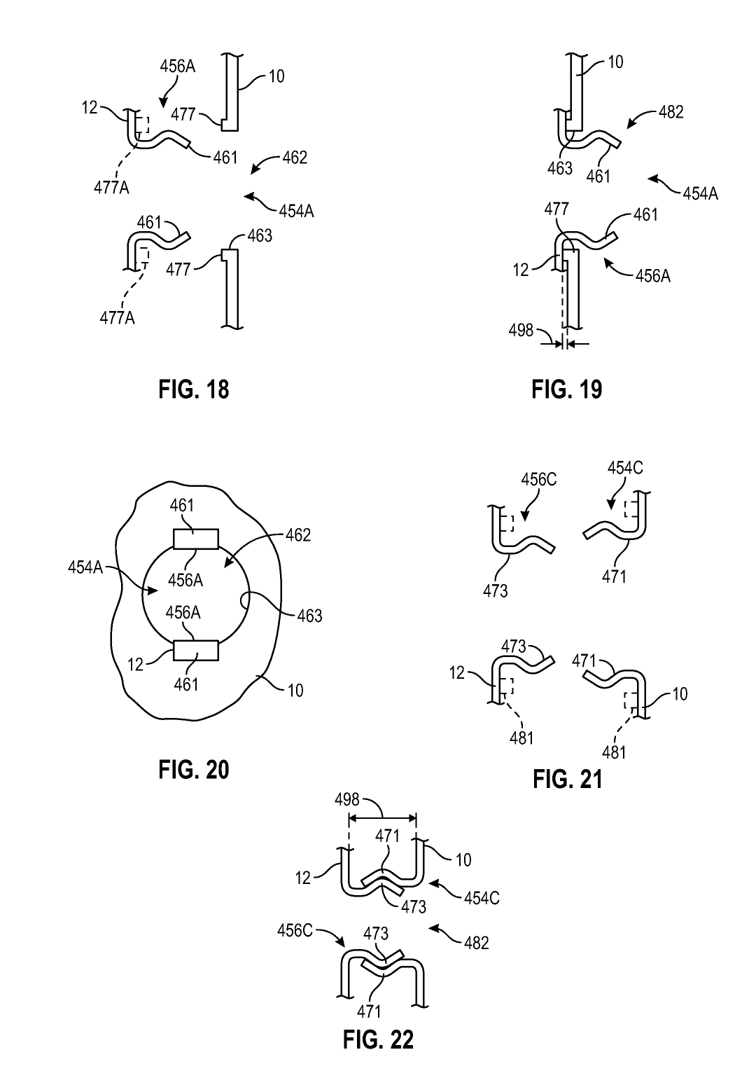

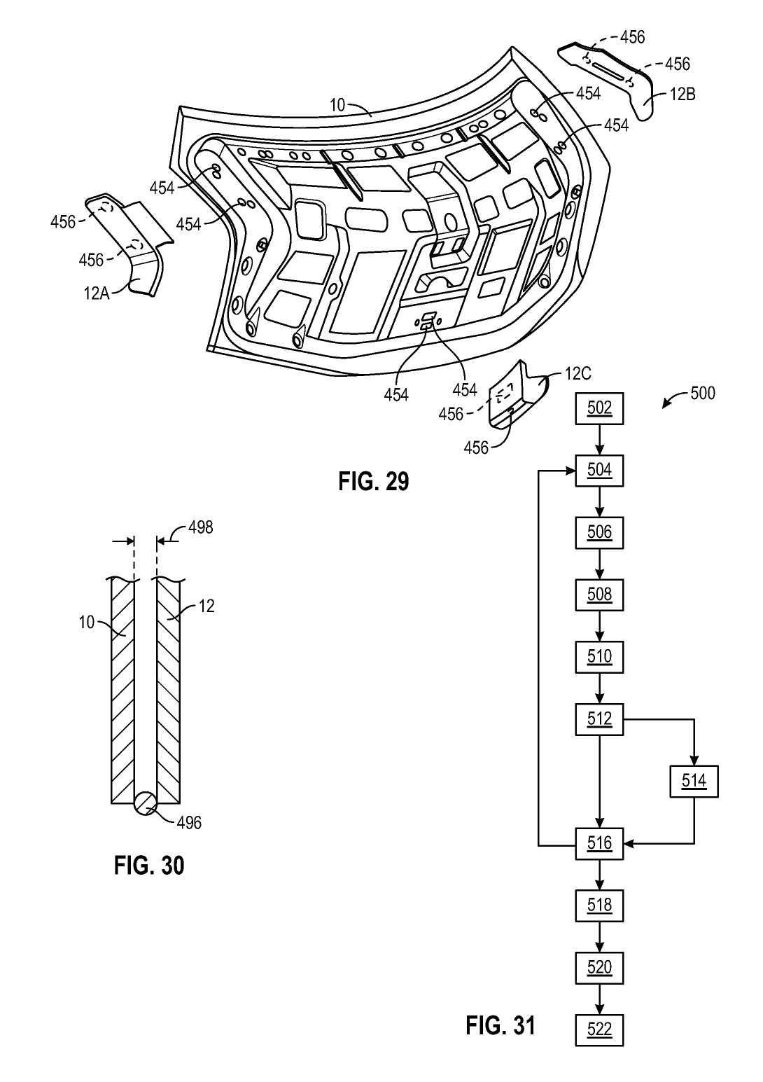

Referring to FIGS. 18-31, aspects of the present teachings are shown in which the first component 10 includes a first fastening feature 454A, 454B, or 454D (referred to generally herein as 454), and the second component 12A, 12B, or 12C (referred to generally herein as 12) includes a second fastening feature 456A, 456B, or 456D (referred to generally herein as 456). The first and second fastening features 454, 456 engage each other to secure or attach together the first and second components 10, 12A, 12B, 12C. In certain embodiments, the first fastening feature 454 is further defined as a plurality of first fastening features 454 and the second fastening feature 456 is further defined as a plurality of second fastening features 456. When utilizing a plurality of fastening features 454, 456, at least one of the second fastening features 456 engages at least one of the first fastening features 454. Therefore, in certain embodiments, a plurality of second fastening features 456 can engage one of the first fastening features 454 and vice versa. Alternatively, one of the second fastening features 456 can engage one of the first fastening features 454, and another one of the second fastening features 456 can engage another one of the first fastening features 454, etc. The first and second fastening features 454, 456 can engage each other in any suitable way, such as friction or interference fit, press fit, snap fit, elastic fit, etc.

The first and second fastening features 454, 456 can be integral formed with respective first and second components 10, 12A, 12B, 12C, i.e., formed of one piece or unit, or can be attached to respective first and second components 10, 12A, 12B, 12C by any suitable methods, i.e., welding, adhesive, fasteners, etc. When attaching the first and second fastening features 454, 456, this can occur any time after forming the first and second components 10, 12A, 12B, 12C, such as just prior to securing together the first and second components 10, 12A, 12B, 12C. The first and second fastening features 454, 456 provide a minimum holding force of the second component 12A, 12B, 12C relative to the first component 10. The first and second fastening features 454, 456 eliminate the use of dedicated fixtures to present, position, or hold the components 10, 12A, 12B, 12C.

The vision system 16 can be utilized to align the first fastening feature 454 and the second fastening feature 456 relative to each other. When utilizing the plurality of fastening features, the vision system 16 can be utilized to align the first fastening features 454 and the second fastening features 456 relative to each other. Therefore, the vision system 16, such as the cameras 18, can be used to find the location that the first and second fastening features 454, 456 or the coordinate locator can be utilized to align the first fastening feature(s) 454 and the second fastening feature(s) 456 to a particular location to engage each other. The first fastening feature(s) 454 and the second fastening feature(s) 456 can be many different configurations, some of which are discussed below.

Once the components 10, 12A, 12B, 12C are located relative to one another, a process joint 482 is created or established to hold the components 10, 12A, 12B, 12C in the relative positions (including standoff distance 498 between materials when desired) until a structural joint 496 (see FIG. 30) or structural weld is created in a subsequent operation. The structural joint 496 provides a permanent attachment between the components 10, 12A, 12B, 12C.

Clamps are replaced by one or more process joints 482. In other words, the first and second fastening features 454, 456 create the process joint 482 to eliminate the need for clamps to hold the components 10, 12A, 12B, 12C to one another during a subsequent laser welding or resistance spot welding operation. The process joint 482 has a predetermined strength as mentioned above, which can be referred to as a first predetermined strength. When the structural joint 496 is created, the structural joint 496 has a second predetermined strength greater than the first predetermined strength. Therefore, the structural joint 496 provides a more permanent attachment between the components 10, 12A, 12B, 12C. Generally, the first and second fastening features 454, 456, and specifically, the process joint 482, provides a predetermined strength sufficient to hold or maintain the second component 12A, 12B, 12C in the desired predetermined position until the subsequent structural joint 496 is provided, such as by laser welding, resistance spot welding, etc.

The structural joint 496 can be laser welded, resistance spot welded, other fusion bonding or welding (e.g. metal inert gas (MIG) weld), solid state bond (e.g. ultrasonic weld or friction stir weld), mechanical joint (e.g. rivet, flow drill screw or mechanical clinching), structural adhesive, or a hybrid method of the above (combinations of one or more of the above methods) which is configured to hold the first and second components 10, 12A, 12B, 12C to one another throughout the useful life of the assembly when installed on a vehicle, appliance, etc. In certain embodiments, the process joint 482 and the vision system 16 can enable rapid one-sided or two-sided re-spot welding, such as but not limited to remote laser welding or resistance spot welding. The re-spot welding is performed subsequent to the process joint 482, and the re-spot weld can be performed on the support 30 or on a fixture that does not utilize clamps which can reduce complexity and costs, as well as improve accessibility for welding.

The structural joint 496 or weld can be in any suitable location relative to the process joint 482. In some instances, the structural joint 496 can be formed away from the process joint 482, i.e., spaced from each other. In other instances, the structural joint 496 can be formed proximal or near the process joint 482. In yet other instances, the structural joint 496 can be formed over the process joint 482.

Turning to the different fastening features 454, 456, FIGS. 18-20, illustrates one embodiment. In this embodiment, one of the first and second fastening features 454A, 456A includes a tab 461 and the other one of the first and second fastening features 454A, 456A defines an aperture 462. The tab 461 is disposed in the aperture 462 to create the process joint 482. For example, the first fastening feature 454A can define the aperture 462 and the second fastening feature 456A can be the tab 461. The first component 10 can include an inner wall 463 encircling the aperture 462, with the tab 461 engaging the inner wall 463 to secure together the first and second components 10, 12. The tab 461 is biasable to apply a force to the first component 10, such as the inner wall 463, to maintain the relative position of the second component 12 relative to the first component 10. Generally, the tab 461 snap fits to the first component 10. It is to be appreciated that the tab 461 can be stamped and bent to the desired orientation. The tab 461 can be stamped during or after the formation of the first or second component 10, 12.

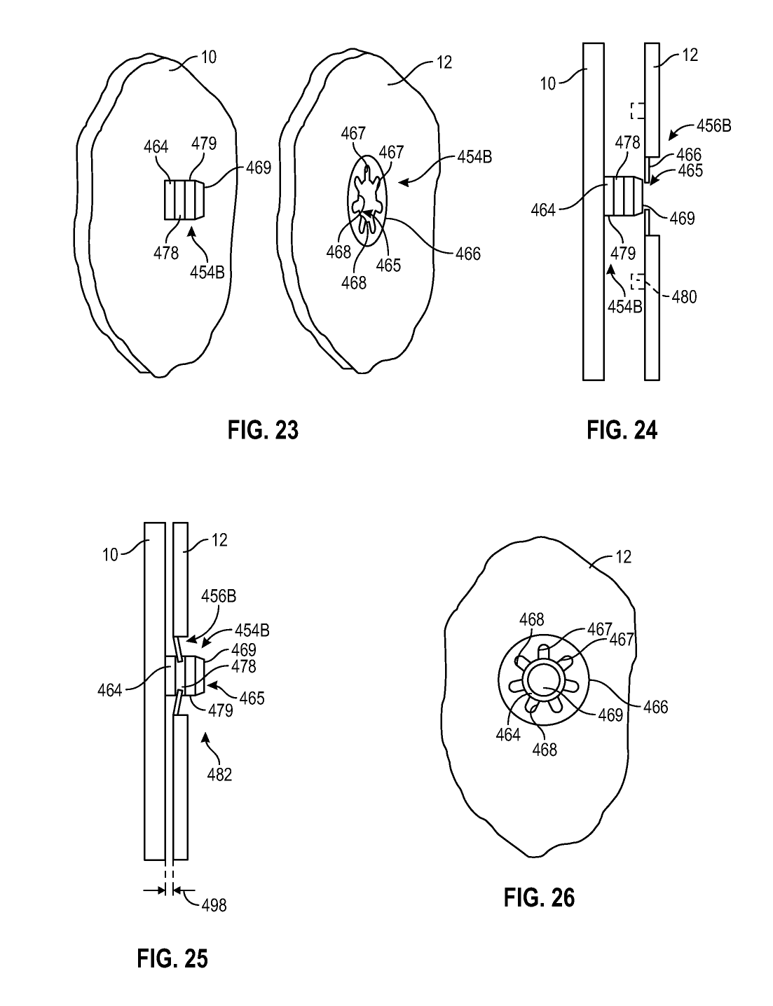

Turning to the embodiment of FIGS. 23-26, one of the first and second fastening features 454B, 456B includes a protrusion 464 and the other one of the first and second fastening features 454B, 456B defines an opening 465. The protrusion 464 is disposed in the opening 465 to create the process joint 482. For example, the first fastening feature 454B can be the protrusion 464 and the second fastening feature 456B can be defined as the opening 465. Specifically, in this embodiment, the second fastening feature 456B can include a retention member 466 defining the opening 465. The retention member 466 can be flexible such that the protrusion 64 deforms the retention member 466 when engaging each other. Specifically, the retention member 466 is elastically deformable such that the retention member 466 returns to its original configuration when the protrusion 464 disengages the retention member 466.

The retention member 466 can be formed into the second component 12 or be an insert that is attached to the second component 12. The retention member 466 can be a different thickness from or the same thickness as the second component 12. FIGS. 24 and 25 illustrate the retention member 466 having a different thickness than the second component 12. The opening 465 can be any suitable configuration, and FIGS. 23 and 26 illustrates the opening 465 as having a plurality of indents 467 extending radially away from the center of the opening 465 such that the retention member 466 presents a plurality of fingers 468, with the fingers 468 being flexible. The indents 467 provide additional flexibility between the fingers 468 such that the fingers 468 can bias and deform. Therefore, generally, the protrusion 464 snap fits or press fit to the retention member 466.

The indents 467 defined by the retention member 466 allow for some variation or play in the centering of the protrusion 464 relative to the opening 465. In other words, the protrusion 464 has a diameter slightly smaller than a maximum width of the center opening 465. When several protrusions 464 are positioned at different locations on the first component 10, these protrusions 464 have to align with several different center openings 465 of the retention members 466. The ability to align each respective pair of protrusions 464 and openings 465 is provided by allowing some play which enables the components 10, 12 to be fit to one another within the range of dimensional tolerances of the features 454B, 456B. For example, if one of the protrusions 464 is slightly offset from the center of the respective opening 465, the fingers 468 of the retention members 466 can elastically deform to self-align the components 10, 12 to one another. The average of the elastic deformation between all of the pairs of protrusions 464 and the retention members 466 aligns the first component 10 relative to the second component 12. Therefore, in the embodiment of FIGS. 23-26, the first and second fastening features 454B, 456B can be designed to provide elastic averaging to self-align the second components 12 relative to the first component 10.

The protrusion 464 can be integrally formed with or attached to the first component 10. For example, the protrusion 464 can be welded or stamped to the first component 10. The protrusion 464 can extend outwardly from the first component 10 to a distal end 469. Optionally, the distal end 469 can be tapered to assist in inserting and/or aligning the protrusion 464 with the opening 465.

Referring to the embodiment of FIGS. 21 and 22, the first fastening feature 454C includes a first tab 471 and the second fastening feature 456C includes a second tab 473. The first and second tabs 471, 473 engage each other to create the process joint 482. The first and second tabs 471, 473 are biasable to apply a force against each other to maintain the relative position of the second component 12 relative to the first component 10. Generally, the first and second tabs 471, 473 snap fit to each other. It is to be appreciated that the first and second tabs 471, 473 can be stamped and bent to the desired orientation.

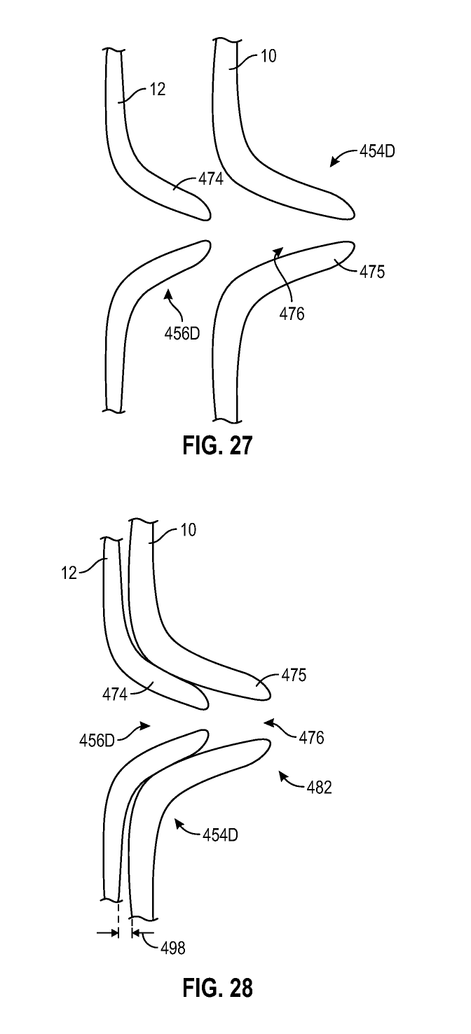

Turning to the embodiment of FIGS. 27 and 28, one of the first and second fastening features 454D, 456D includes a first projection 474 and the other one of the first and second fastening features 454D, 456D includes a second projection 475 defining a hollow 476. The first projection 474 is disposed in the hollow 476 of the second projection 475 to create the process joint 482. Therefore, the second projection 475 is larger than the first projection 474 such that the first projection 474 can fit into the hollow 476. For example, the first fastening feature 454D can include the first projection 474 and the second fastening feature 456D can include the second projection 475 defining the hollow 476. The first projection 474 is inserted into the hollow 476 of the second projection 475 until the first and second projections 474, 475 engage each other. Specifically, the first and second projections 474, 475 create a friction fit or press-fit therebetween. The first projection 474 can optionally define a hollow. It is to be appreciated that the hollow 476 of the first and second projections 474, 475 can be completely or entirely through the first and second components 10, 12.

In certain embodiments, referring to FIGS. 19, 22, 25 and 28, the process joint 482 can establish a standoff distance 498 (i.e. gap) between the first component 10 and the second component 12. In certain embodiments, the first and second fastening features 454, 456 can establish the standoff distance 498. For example, in certain embodiments, the first fastening feature 454 and the second fastening feature 456 engage each other to establish the standoff distance 498 between the first component 10 and the second component 12.

The standoff distance 498 can assist subsequent welding processes. The standoff distance 498 correlates with the placement of the subsequent structural weld that affixes the first and second components 10, 12 together. For example, if laser welding is used for the structural joint 496, it can be desirable to have the standoff distance 498 between components 10, 12. For example, laser welding of zinc coated steels can have improved quality with reduced porosity when the materials have a standoff distance 498 from about 0.1 millimeters (mm) to about 0.2 mm in the area of the weld. This standoff distance 498 can improve weld quality by allowing welding gasses to escape from the welded area prior to solidification.

In some cases, the standoff distance 498 should be minimized. For example laser welding of aluminum to aluminum should be done with a minimized standoff distance 498 (e.g., less than about 0.125 mm) in the area of the weld.

For the embodiment of FIGS. 18-20, the standoff distance 498 can be established by an extension 477. At least one of the tab 461 and one of the first and second fastening features 454A, 456A adjacent to the aperture 462 includes the extension 477 to limit the distance the tab 461 is inserted into the aperture 462 to establish the standoff distance 498. In one embodiment, the first fastening feature 454A of the first component 10 includes the extension 477 which is shown in solid lines in FIGS. 18 and 19. For example, the extension 477 can be disposed adjacent to the aperture 462, as such, the extension 477 can extend from the first component 10 adjacent to the aperture 462. In another embodiment, the tab 461 includes the extension indicated as 477A, as shown in phantom lines in FIG. 18. In other embodiments, the tab 461 and the first component 10 can both include an extension 477 or 477A. It is to be appreciated that one or more extensions 477 or 477A can be utilized and disposed in any suitable location. By changing the thickness of the extension 477 or 477A, the standoff distance 498 accordingly changes. The phrase “at least one of” as used herein should be construed to include the non-exclusive logical “or”, i.e., at least one of the tab 461 or one of the first and second fastening features 454A, 456A. Therefore, in certain embodiments, the tab 461 includes the extension 477 or 477A or one of the first and second fastening features 454A, 456A includes the extension 477. In other embodiments, the tab 461 and one of the first and second fastening features 454A, 456A both include the extension 477 or 477A. The same principle with regard to the phrase “at least one of” applies to this entire specification.

For the embodiment of FIGS. 23-26, the standoff distance 498 can be established by a groove 478. Specifically, the protrusion 464 can include an outer periphery 479 defining the groove 478. The retention member 466 engages the groove 478 to limit the distance that the protrusion 464 is inserted into the opening 465 of the retention member 466 to establish the standoff distance 498. By changing the location of the groove 478, the standoff distance 498 accordingly changes.

In addition to, or alternatively to utilizing the groove 478 to establish the standoff distance 498, the standoff distance 498 can be established by an extension 480 as shown in phantom lines in FIG. 24. At least one of the first and second components 10, 12 includes the extension 480 to limit the distance that the protrusion 464 is inserted into the opening 465 to establish the standoff distance 498. For example, the extension 480 can extend from the second component 12, the first component 10 or both of the first and second components 10, 12. In FIG. 24, for illustrative purposes only, the extension 480 extends from the second component 12. Again, by changing the thickness of the extension 480, the standoff distance 498 accordingly changes. The extension 480 can be in any suitable location and one suitable location can be adjacent to the retention member 466.

For the embodiment of FIGS. 21 and 22, the standoff distance 498 can be established by an extension 481. At least one of the first and second tabs 471, 473 includes the extension 481 to limit the distance that the first and second tabs 471, 473 engage each other to establish the standoff distance 498. Therefore, in one embodiment, the first tab 471 includes the extension 481. In another embodiment, the second tab 473 includes the extension 481. In yet another embodiment, the first and second tabs 471, 473 each include an extension 481. The optional extension 481 is shown in phantom lines in FIG. 21.

Turning to the embodiment of FIGS. 27 and 28, at least one of the first and second projections 474, 475 are tapered to limit the distance the first projection 474 is inserted into the hollow 476 to establish the standoff distance 498. In one embodiment, the first projection 474 is tapered. In another embodiment, the second projection 475 is tapered. In yet another embodiment, both of the first and second projections 474, 475 are tapered, as shown for illustrative purposes only in FIGS. 27 and 28. Furthermore, the first and/or second projections 474, 475 can be bent in a desired configuration to establish the standoff distance 498.

FIG. 31 illustrates a flow diagram of the method 500 of assembling a plurality of components 10, 12A, 12B, 12C, and FIG. 4 shows one example of the assembly system 200 utilizing the method 500 from the introduction of the components 10, 12A, 12B, 12C to finish hemming.

In FIG. 31, the method 500 can include block 502, in which the robot 23 picks up the first component 10 from an unfixtured initial support 13, such as a standard flat belt conveyor, a storage bin, a tote or a shipping rack. The initial support 13 is shown as a shipping rack in FIG. 4. The controller C (shown in FIGS. 5 and 6) determines a location of the unfixtured first component 10 on the initial support 13 using any suitable locating system such as vision system 16.

Referring again to FIGS. 4 and 31, in block 504 of the method 500, the first component 10 is placed on the support 30 without fixtures using the robot 23. The robotic arm 22 is then actuated by the controller C to retrieve the first component 10 with the end effector 26 from the conveyor belt 14. The end effector 26 or grippers 28 engage the first component 10 using the determined location from the visual position data of the vision system 16.

The robotic system 24 can optionally include a force sensor 31 (see FIG. 6) in communication with the controller C to measure an amount of force applied to at least one of the first component 10 and the second component 12A, 12B, 12C such as when the first and second fastening features 454, 456 engage each other. In other words, the force sensor 31 measures the load applied to at least one of the first component 10 and the second component 12A, 12B, 12C. Specifically, the force sensor 31 can measure the load applied to the first and/or second fastening features 454, 456. The force sensor 31 can ensure that the first and second fastening features 454, 456 engage each other to secure the second components 12A, 12B, 12C to the first component 10. Depending on the configuration of the first and second fastening features 454, 456, the force sensor 31 can measure changes in the load, such as a decrease in force (i.e., force fall off) or an increase in force, to determine what stage of engagement is occurring between the first and second fastening features 454, 456. Furthermore, the force sensor 31 can minimize undesirable deformation of the first and/or second components 10, 12A, 12B, 12C. As discussed with respect to FIG. 6, generally, the force sensor 31 can be disposed on the end effector 26. In one embodiment, the force sensor 31 is disposed on one or more of the grippers 28. It is to be appreciated that one or more force sensors 31 can be utilized and the force sensor(s) 31 can be any suitable location.

Referring to FIG. 31, the method 500 can include block 506, in which the location of the first component 10 is determined when on the support 30 via the vision system 16. At block 508 of the method 500, the location of the second component 12A, 12B, 12C is determined via the vision system 16. The data regarding the locations of the first and second components 10, 12A, 12B, 12C is communicated to the controller C. As mentioned above, the second components 12A, 12B, 12C are located and placed one at a time, which is also discussed further below. It is to be appreciated that more than one second component 12A, 12B, 12C can be placed at one time when utilizing a plurality of robots 23.

Referring again to FIGS. 4 and 31, once the first component 10 is positioned on the support 30, block 506 and 508 continues by using the vision system 16 to determine the location of the first component 10 on the support 30 and the location of the second component 12A, 12B, 12C. Once the first component 10 is placed on the fixtureless support 30 and the desired data is obtained, one of the second components 12A, 12B, 12C can be picked up. Specifically, the location of the second component 12A, 12B, 12C is determined and then picked up. In certain embodiments, more than one location of the first component 10 can be determined by the vision system 16 and/or more than one location of the second component 12A, 12B, 12C can be determined by the locating system 16.

The method 500 can be designed so that the second components 12A, 12B, 12C are those that are smaller in size than the first component 10.

At block 510 of the method 500, the second component 12A, 12B, 12C is positioned relative to the first component 10 using the robot 23 based on the determined location of the first component 10 on the support 30 via the vision system 16. For example, when utilizing the vision system, the camera(s) 18 or laser(s) collects data regarding the locations which is utilized for accurately placing the second component 12A, 12B, 12C relative to the first component 10 via the robotic system 24.

The method 500 then proceeds to block 512 in which the first fastening feature 454 of the first component 10 and the second fastening feature 456 of the second component 12A, 12B, 12C are engaged together according to the positioning of the second component 12A, 12B, 12C relative to the first component 10 based on the locations determined by the vision system 16 to create the process joint 482 having the first predetermined strength that holds the second component 12A, 12B, 12C relative to the first component 10. As discussed above, the process joint 482 is provided to hold or maintain a desired position of the second component 12A, 12B, 12C relative to the first component 10. In other words, the process joint 482 is the mechanism by which the first component 10 and any of the second components 12A, 12B, 12C are held relative to one another prior to creating one or more structural joints 496. The support 30 and the process joint 482 thus serve as the geometry setting features of the first component 10 and the second components 12A, 12B, 12C prior to creating the structural joints 496. As such, the first and second fastening features 454, 456 secure together the first and second components 10, 12A, 12B, 12C such that subsequent processes can be performed to these components 10, 12A, 12B, 12C. The first and second fastening features 454, 456 can engage each other by utilizing the robotic system 24, or alternatively, can engage each other by an operator or worker manually.

In certain embodiments, engaging together the first fastening feature 454 of the first component 10 and the second fastening feature 456 of the second component 12A, 12B, 12C (block 512) further includes inserting the tab 461 into the aperture 462 to create the process joint 482 (see embodiment of FIGS. 18 and 19). In other embodiments, engaging together the first fastening feature 454 of the first component 10 and the second fastening feature 56 of the second component 12A, 12B, 12C (block 512) further includes inserting the protrusion 464 into the opening 465 to create the process joint 482 (see embodiment of FIGS. 23-25). More specifically, inserting the protrusion 464 into the opening 465 to create the process joint 482 further includes inserting the protrusion 464 into the retention member 466 defining the opening 465. In this embodiment, the method 500 can proceed to block 514 in which the retention member 466 is deformed as the protrusion 464 is inserted into the opening 465.

In yet other embodiments, engaging together the first fastening feature 454 of the first component 10 and the second fastening feature 456 of the second component 12A, 12B, 12C (block 512) further includes engaging together the first tab 471 and the second tab 473 to create the process joint 482 (see embodiment of FIG. 22) In yet another embodiment, engaging together the first fastening feature 454 of the first component 10 and the second fastening feature 456 of the second component 12A, 12B, 12C (block 512) further includes inserting the first projection 474 into the hollow 476 of the second projection 475 to create the process joint 482 (see embodiment of FIG. 28). In various embodiments, a plurality of first fastening features 454 and a plurality of second fastening features 456 can be utilized. In that embodiment, engaging together the first fastening feature 454 of the first component 10 and the second fastening feature 456 of the second component 12A, 12B, 12C (block 512) further includes engaging together the first fastening features 454 with respective second fastening features 456.

Additionally, at block 516 of the method 500, the amount of force applied to at least one of the first component 10 and the second component 12A, 12B, 12C can be measured when engaging together the first and second fastening features 454, 456 via the force sensor 31. Therefore, the force of application of the second component 12A, 12B, 12C onto the first component 10 can be controlled and/or monitored by integrating the force sensor 31 at the end effector 26 on the robotic arm 22, as shown in FIG. 6. It is to be appreciated that block 516 is optional.

Once one of the second components 12A, 12B, 12C is secured to the first component 10 to create the process joint 482, blocks 506 through 516 can be repeated for another one of the second components 12A, 12B, 12C. These blocks are repeated for the desired number of second components 12A, 12B, 12C being utilized. One or more process joints 482 can be created with each of the second components 12A, 12B, 12C. After the desired number of process joints 482 are created, the components 10, 12A, 12B, 12C are considered to be geometrically set in position relative to one another, and the method 500 can proceed to block 518.

Once all of the process joints 482 are created for the desired number of second components 12A, 12B, 12C, the structural joint 496 or weld can be formed to affix the first and second components 10, 12A, 12B, 12C together. The method 500 can include block 518 in which the secured together components 10, 12A, 12B, 12C are removed from the support 30 and placed on a movable support such as the conveyor 14. Alternatively, the secured together components 10, 12A, 12B, 12C remain on the support 30 and are moved to the next station to create the structural joint 496.

At block 520 of the method 500, the final structural connections of the components 10, 12A, 12B, 12C are carried out, such as by welding with laser or resistance spot welds. FIG. 4 illustrates that the components 10, 12A, 12B, 12C with process joints 482 can optionally be inspected by scanning with a three-dimensional vision system 126 at a scanning station 202. If the positioning via the process joints 482 are sufficient, the components 10, 12A, 12B, 12C can be moved by another robot 23 from the conveyor 14 to a remote laser welding station 204 where laser welding can be carried out with a remote laser welder.

Specifically, at block 522 of the method 500, the first component 10 and the second component 12A, 12B, 12C are welded together to create the structural joint 496 after creating the process joint 482. As discussed above, the structural joint 496 has the second predetermined strength greater than the first predetermined strength. The structural joint(s) 96 are stronger than the process joint(s) 482 to more permanently affix the first and second components 10, 12A, 12B, 12C together. The relative position of the first component 10 and the second component 12A, 12B, 12C are maintained without fixtures by the process joint 482 during the welding of the first component 10 and the second component 12A, 12B, 12C together. In certain embodiments, each of the second components 12A, 12B, 12C are structurally welded to the first component 10 one at a time.

It is to be appreciated that the order or sequence of performing the method 500 as identified in the flowchart of FIG. 31 is for illustrative purposes and other orders or sequences are within the scope of the present disclosure. It is to also be appreciated that the method 500 can include other features not specifically identified in the flowchart of FIG. 31.

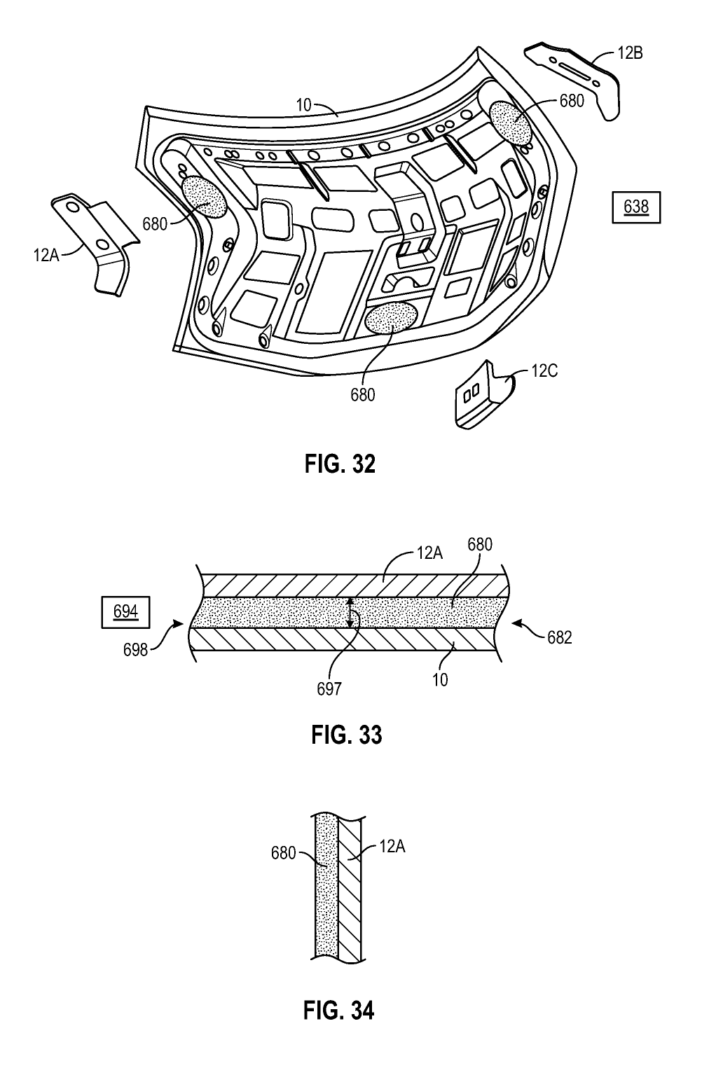

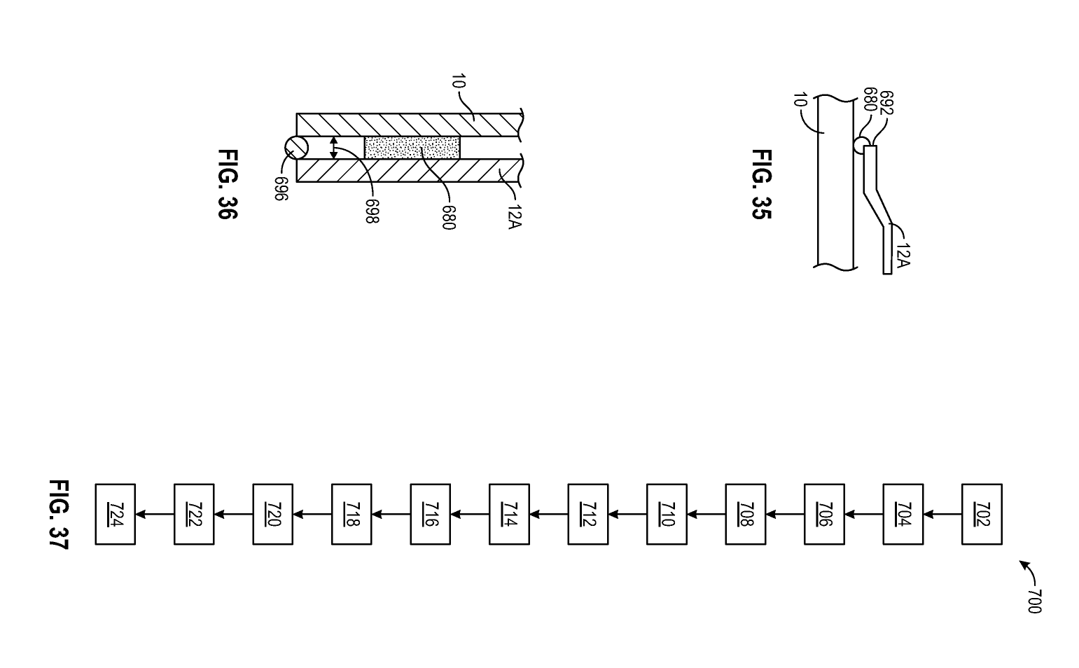

Referring to FIGS. 1, 4 and 32-34, the body shop assembly system 200 further includes an applicator system 638 that applies an adhesive 680 to at least one of the first component 10 and the second component 12A, 12B, 12C. The adhesive 680 may be identical to the adhesive 308 of FIG. 15. The phrase “at least one of” as used herein should be construed to include the non-exclusive logical “or”, i.e., at least one of the first component 10 or the second component 12A, 12B, 12C. Therefore, in certain embodiments, the adhesive 680 is applied to the first component 10 or the second component 12A, 12B, 12C. In other embodiments, the adhesive 680 is applied to both the first component 10 and the second component 12A, 12B, 12C. Simply stated, the adhesive 680 can be applied to either or both of the body components 10, 12A, 12B, 12C prior to relative positioning of the components 10, 12A, 12B, 12C. Utilizing adhesive to secure or attach the second component 12A, 12B, 12C to the first component 10 eliminates obstructions which can occur with fixtures or clamps. Furthermore, eliminating obstructions can improve cycle times and is useful for laser welding applications where clamps can interfere with the laser's line of sight to the part being welded.

The vision system 16 can be utilized to apply the adhesive 680 to the desired location on the first component 10 and/or the second component 12A, 12B, 12C. Therefore, the vision system 16, including the cameras 18, can be used to find the location that the adhesive 680 is to be applied on the component 12A, 12B, 12C or the coordinate locator can be utilized to apply the adhesive 680 to a particular location on the component 12A, 12B, 12C. Generally, the applicator system 638 dispenses the adhesive 680. The adhesive 680 can be dispensed in many different ways, some of which are discussed below.

In one embodiment, the applicator system 638 can include a tub, bin, etc., filled with the adhesive 680 and the second component 12A, 12B, 12C is dipped into the adhesive 680 in the tub via the robot 23. In this embodiment, one side of the second component 12A, 12B, 12C can be dipped into the adhesive 680, and/or one or more edges of the second component 12A, 12B, 12C can be dipped into the adhesive 680, etc. Furthermore, in this embodiment, the second component 12A, 12B, 12C can include one or more projections extending outwardly from the second component 12A, 12B, 12C, and one or more of the projections can be dipped into the adhesive 680.

In another embodiment, the applicator system 638 can include a dispenser, such as a brush, a nozzle, a glue gun, a spray gun, a glue bottle, etc., in which the robot 23 applies the adhesive 680 to at least one of the first component 10 and the second component 12A, 12B, 12C with the dispenser. In one embodiment, the dispenser can be stationary such that the robot 23 moves the second component 12A, 12B, 12C relative to the dispenser. In another embodiment, the robot 23 moves the dispenser relative to the first component 10 and/or the second component 12A, 12B, 12C.

In yet another embodiment, the second component 12A, 12B, 12C can be dipped into the adhesive 680 and/or the adhesive 680 can be applied with the applicator by hand via a worker or operator. In other words, the adhesive 680 can be manually applied by the worker. Therefore, the adhesive 680 can be manually applied to the first component 10 and/or the second body components 12A, 12B, 12C.

The type of adhesive 680 used is specifically designed so that it does not affect any subsequent processes or stations. For example, for vehicle applications, the type of adhesive 680 will not affect the paint applied to one or more of the body components 10, 12A, 12B, 12C. Generally, the adhesive 680 chosen can have low shrinkage. The adhesive 680 can be structural adhesive, cyanoacrylate adhesive, hot melt adhesive, heat cure adhesive, 2-part adhesive, infrared (IR) cure adhesive, ultraviolet (UV) cure adhesive, light cure adhesive or any other suitable adhesive. For example, the adhesive 680 can be a LOCTITE® adhesive product commercial available from Henkel Corporation. Below are two charts of suitable LOCTITE® adhesive products. The shear strength listed in the charts below is based on grit-blasted steel.

| | CHART 1 | | |
|---|---|---|---|
| | Product Type | | |
| | | Loctite ® | Loctite ® |
| | Loctite ® | 406 ™ Instant | 401 ™ Instant |
| | 770 ™ Primer | Adhesive | Adhesive |
| Gap Fill | N/A | 0.004 | 0.005 |
| (inches - in.) | | | |
| Viscosity | 1.25 | 20 | 90 |
| (centipoise - cP) | | | |
| Shear Strength | N/A | 3,200 | 3,200 |
| (pounds per | | | |
| square inch - psi) | | | |
| Temperature | N/A | −65° F. (−54° C.) | −65° F. (−54° C.) |
| Range | | to 250° F. | to 250° F. |
| | | (121° C.) | (121° C.) |
| Fix Time | N/A | 15 | 15 |
| (seconds - sec.) | | | |

| | CHART 2 | | |
|---|---|---|---|
| | Product Type | | |
| | Loctite ® | Loctite ® | Loctite ® |
| | 454 ™ Instant | 403 ™ Instant | 455 ™ Instant |
| | Adhesive | Adhesive | Adhesive |
| Gap Fill | 0.010 | 0.008 | 0.010 |
| (inches - in.) | | | |
| Viscosity | Gel | 1,200 | Gel |
| (centipoise - | | | |
| cP) | | | |
| Shear Strength | 3,200 | 2,600 | 2,600 |
| (pounds per | | | |
| square inch - | | | |
| psi) | | | |
| Temperature | −65° F. (−54° C.) | −65° F. (−54° C.) | −65° F. (−54° C.) |
| Range | to 250° F. | to 200° F. | to 200° F. |
| | (121° C.) | (93° C.) | (93° C.) |
| Fix Time | 15 | 50 | 40 |
| (seconds - sec.) | | | |

The adhesive 680 is applied to one or both of the first and second body components 10, 12A, 12B, 12C before positioning the second component 12A, 12B, 12C, and thus adhering the second component 12A, 12B, 12C to the first component 10. In certain embodiments, the adhesive 680 is applied to the second component 12A, 12B, 12C, and the second component 12A, 12B, 12C is adhered to the first component 10 such that the adhesive 680 is positioned between the first component 10 and the second component 12A, 12B, 12C to create the process joint 682. Simply stated, the adhesive 680 can be placed between the first component 10 and the second component 12A, 12B, 12C.

In other embodiments, the first and second body components 10, 12A, 12B, 12C are positioned relative to each other and the adhesive 680 is applied to an edge 692 (see FIG. 35) of the second component 12A, 12B, 12C which causes the adhesive 680 to wick between the first and second body components 10, 12A, 12B, 12C to create the process joint 682. In yet other embodiments, the adhesive 680 can be applied to an edge of the first component 10 which causes the adhesive 680 to wick between the first and second body components 10, 12A, 12B, 12C to create the process joint 682. It is to be appreciated that the adhesive 680 can be applied to the first and/or the second body components 10, 12A, 12B, 12C in any suitable location to create the process joint 682.

Depending on the type of adhesive 680 and the application that the adhesive 680 is being used for, the adhesive 680 should cure or dry in a reasonable amount of time as to not delay any subsequent procedures at other stations, etc. The term “cure” used herein can include both fully cured and partially cured, i.e., not fully cured to a full strength bond. Therefore, cured can be when the adhesive 680 is fully cured to a full strength bond or partially cured such that the adhesive 680 meets a predetermined shear strength. Said differently, the adhesive is cured when a sufficient bond occurs between the first and second components 10, 12 to hold or maintain the second component 12 relative to the first component 10, which can occur when fully cured or partially cured.

Generally, the adhesive 680 is a quick-drying adhesive. The cure time can depend on environmental conditions, such as temperature, humidity, etc., as well as the properties of the adhesive 680, materials of the first and/or second body components 10, 12A, 12B, 12C, and/or the surface characteristics of the first and/or second body components 10, 12A, 12B, 12C. In certain assembly operations, the process joint 682 is cured in about less than 60 seconds. For example, the process joint 682 is cured from about 1.0 seconds to about 50.0 seconds after adhering together the first and second body components 10, 12A, 12B, 12C. As one example, a cure time of 5.0 seconds or less can be utilized. Other examples of suitable cure times are listed above in the charts as “fix time”. The phrase “fix time” in the charts refers to the time to cure the adhesive to a predetermined shear strength that is less than full strength, i.e., not fully cured. The components 10, 12A, 12B, 12C can move to the next station or stage when the adhesive 680 is dry enough to hold or maintain the position of the second component 12A, 12B, 12C relative to the first component 10. It is to be appreciated that the cure time is long enough to adhere together the components 10, 12A, 12B, 12C, i.e., does not cure before the components are placed relative to each other.

The body shop assembly system 200 can also include an accelerator 694 (see FIG. 33) that is applied to the process joint 682 to decrease the time to cure the process joint 682. The accelerator 694 can be any suitable methods, materials, members, etc., to decrease the time to cure the process joint 682. The accelerator 694 can be heat, pressure, moisture, one or more catalysts and/or one or more additives. For example, heat can be applied by an oven, a blower, etc. As another example, pressure can be applied by a member. As yet another example, additives can be added to the adhesive 680 before or after application to the components 10, 12A, 12B, 12C. The accelerator 694 can use infrared hardening, temperature hardening, chemical hardening, etc. It is to be appreciated that the type of accelerator 694 can be selected based on the type of adhesive 680 being used, or vice versa.

Once the components 10, 12A, 12B, 12C are located relative to one another, the process joint 682 is created or established to hold the components 10, 12A, 12B, 12C in the relative positions (including standoff distance 698 between materials when desired) until a structural joint 696 (see FIG. 36) or structural weld is created in a subsequent operation. The structural joint 696 provides a permanent attachment between the components 10, 12A, 12B, 12C.

One or more process joints 682 are used in lieu of clamps. The process joint 682 has a predetermined strength as mentioned above, which can be referred to as a first predetermined strength. When the structural joint 696 is created, the structural joint 696 has a second predetermined strength greater than the first predetermined strength. Therefore, the structural joint 696 provides a more permanent attachment between the body components 10, 12A, 12B, 12C. Generally, once the adhesive 680 cures, the adhesive 680, and specifically, the process joint, provides a predetermined strength sufficient to hold or maintain the second component 12A, 12B, 12C in the desired predetermined position until the subsequent structural joint 696 is provided, such as by laser welding, resistance spot welding, etc.

The structural joint 696 can be laser welded, resistance spot welded, other fusion bonding or welding (e.g. metal inert gas (MIG) weld), solid state bond (e.g. ultrasonic weld or friction stir weld), mechanical joint (e.g. rivet, flow drill screw or mechanical clinching), structural adhesive, or a hybrid method of the above (combinations of one or more of the above methods) which is configured to hold the first and second components 10, 12A, 12B, 12C to one another throughout the useful life of the assembly when installed on a vehicle, appliance, etc. In certain embodiments, the process joint 682 and the vision system 16 can enable rapid one-sided or two-sided re-spot welding, such as but not limited to remote laser welding or resistance spot welding. The re-spot welding is performed subsequent to the process joint 682, and the re-spot weld can be performed on the support 30 or on a fixture that does not utilize clamps which can reduce complexity and costs, as well as improve accessibility for welding.

The structural joint 696 or weld can be in any suitable location relative to the process joint 682. In some instances, the structural joint 96 can be formed away from the process joint 682, i.e., spaced from each other. In other instances, the structural joint 696 can be formed proximal or near the process joint 682. By creating the structural joint 696 away from the process joint 682, heating/burning the adhesive 680 can be minimized and porosity in the weld can be minimized. In yet other instances, the structural joint 696 can be formed over the process joint 682.

In certain embodiments, referring to FIG. 36, the process joint 682 can establish a standoff distance 698 (i.e., gap) between the first component 10 and the second component 12A, 12B, 12C. In certain embodiments, the adhesive 680 can establish the standoff distance 698. For example, in certain embodiments, the adhesive 680 has a thickness 697 (see FIG. 33) that establishes the standoff distance 698 between the first component 10 and the second component 12A, 12B, 12C. The viscosity of the adhesive 680 can also influence the standoff distance 698. Therefore, the adhesive 680 can be selected based on the viscosity of the adhesive 680 to create the desired standoff distance 698. In other embodiments, the standoff distance 698 can be obtained by one or more protrusions or dimples in the surface of the first and/or second body components 10, 12A, 12B, 12C instead of, or in addition to, utilizing the process joint 682 to create the standoff distance 698. It is to be appreciated that powders can be utilized to assist in controlling the standoff distance 698.

The standoff distance 698 can assist subsequent welding processes. The standoff distance 698 correlates with the placement of the subsequent structural weld that affixes the first and second body components 10, 12A, 12B, 12C together. For example, if laser welding is used for the structural joint 696, it can be desirable to have the standoff distance 698 between components 10, 12A, 12B, 12C. For example, laser welding of zinc coated steels can have improved quality with reduced porosity when the materials have a standoff distance 98 from about 0.1 millimeters (mm) to about 0.2 mm in the area of the weld. This standoff distance 698 can improve weld quality by allowing welding gasses to escape from the welded area prior to solidification.

In some cases, the standoff distance 698 should be minimized. For example laser welding of aluminum to aluminum should be done with a minimized standoff distance 698 (e.g., less than about 0.125 mm) in the area of the weld.

FIG. 37 illustrates a flow diagram of a method 700 of assembling a plurality of body components 10, 12A, 12B, 12C, and FIG. 4 shows one example of the body shop system 200 utilizing the method 700 from the introduction of the components 10, 12A, 12B, 12C to finish hemming.

In FIG. 37, the method 700 can include block 702, in which the robot 23 picks up the first component 10 from an unfixtured initial support 13, such as a standard flat belt conveyor, a storage bin, a tote or a shipping rack. The initial support 13 is shown as a shipping rack in FIG. 4.

Referring again to FIGS. 4 and 37, in block 704 of the method 700, the first component 10 is placed on the support 30 without fixtures using the robot 23. The method 700 can include block 706, in which the location of the first component 10 is determined when on the support 30 via the vision system 16. At block 708 of the method 700, the location of the second component 12A, 12B, 12C is determined via the vision system 16. The data regarding the locations of the first and second body components 10, 12A, 12B, 12C is communicated to the controller C. Once the first component 10 is positioned on the support 30, block 708 continues by using the vision system 16 to determine the location of the first component 10 on the support 30 and the location of the second component 12A, 12B, 12C.

The method 700 can be designed so that the second body components 12A, 12B, 12C are those that are smaller in size than the first component 10. The second body components 12A, 12B, 12C can be sufficiently small to be presented for assembly in fixtureless bins 90, as indicated in FIG. 4.

The method 700 then proceeds to block 710, in which the adhesive 680 is applied to at least one of the first component 10 and the second component 12A, 12B, 12C. As discussed above, adhesive 680 can be applied to the first and/or the second body components 10, 12A, 12B, 12C. In one embodiment, the adhesive 680 is applied to the second component 12A, 12B, 12C. In another embodiment, the adhesive 680 is applied to the first component 10. When there is a plurality of second body components 12A, 12B, 12C, adhesive 680 is applied to the body components 12A, 12B, 12C one at a time. Adhesive 680 can be applied before determining the location of the second component 12A, 12B, 12C when the adhesive 680 is applied to the first component 10. The adhesive 680 can be applied in many different ways as discussed above. For example, the adhesive 680 can be applied to the side of the first and/or second body components 10, 12A, 12B, 12C. As another example, the adhesive 680 can be applied to the edge of the second component 12A, 12B, 12C which causes the adhesive 680 to wick between the first and second body components 10, 12A, 12B, 12C.

At block 712 of the method 700, the second component 12A, 12B, 12C is positioned relative to the first component 10 using the robot 23 based on the determined location of the first component 10 on the support 30 via the vision system 16. For example, when utilizing the vision system 16, the camera(s) 18 or laser(s) collects data regarding the locations which is utilized for accurately placing the second component 12A, 12B, 12C relative to the first component 10 via the robotic system 24. The second component 12A, 12B, 12C is positioned relative to the first component 10 after applying the adhesive 680.

The method 700 then proceeds to block 714 in which the first component 10 and the second component 12A, 12B, 12C are adhered together according to the positioning of the second component 12A, 12B, 12C relative to the first component 10 based on the locations determined by the vision system 16 to create the process joint 682 having the first predetermined strength that holds the second component 12A, 12B, 12C relative to the first component 10. As discussed above, the process joint 682 is provided to hold or maintain a desired position of the second component 12A, 12B, 12C relative to the first component 10. In other words, the process joint 682 is the mechanism by which the first component 10 and any of the second body components 12A, 12B, 12C are held relative to one another prior to creating one or more structural joints 696. The support 30 and the process joint 682 thus serve as the geometry setting features of the first component 10 and the second body components 12A, 12B, 12C prior to creating the structural joints 696.

Additionally, at block 716 of the method 700, the amount of force applied to at least one of the first component 10 and the second component 12A, 12B, 12C can be measured when adhering the first and second body components 10, 12A, 12B, 12C together via the force sensor 31. Therefore, the force of application of the second component 12A, 12B, 12C onto the first component 10 can be controlled and/or monitored by integrating the force sensor 31 at the end effector 26 on the robotic arm 22, as shown in FIG. 6. The force sensor 31 is in communication with the controller C and is controlled to ensure that the force applied by the end effector 26 to create the process joint 682 remains below a predetermined threshold. For example, when adhesive 680 is used, the force sensor 31 can be controlled to ensure that the desired application force acts on the adhesive 680 without causing deformation of the components 10, 12A, 12B, 12C and/or to ensure the desired thickness 697 of the adhesive 680 to create the desired standoff distance 698 of the process joint 682.

One or more robots 23 can be controlled cooperatively to hold the second component 12A, 12B, 12C in a desired position relative to the first component 10 when applying the adhesive 680 to thereby create the process joint 682. In other words, the controller C can be in communication with one or more robots 23 such that the robots 23 cooperate to hold the second component 12A, 12B, 12C in the desired position relative to the first component 10. Therefore, the method 700 can further include block 718 in which the process joint 682 is cured after adhering together the first and second body components 10, 12A, 12B, 12C. For example, the robot 23 can hold the position of the second component 12A, 12B, 12C relative to the first component 10 until the adhesive 680 cures enough that the second component 12A, 12B, 12C will maintain its position relative to the first component 10. Various cure times are discussed above, and as one example, the process joint 682 can cure from about 1.0 seconds to about 50.0 seconds after adhering together the first and second body components 10, 12A, 12B, 12C.

The method 700 can optionally include block 720 in which the accelerator 694 is applied to the process joint 682 to decrease the time to cure the process joint 682. Different examples of types of accelerators 694 are discussed herein. The accelerator 694 can be applied after applying the adhesive 680 to at least one of the first and second body components 10, 12A, 12B, 12C or any other suitable time.

Once one of the second body components 12A, 12B, 12C is adhered to the first component 10 to create the process joint 682, blocks 706 through 720 can be repeated for another one of the second body components 12A, 12B, 12C. These blocks are repeated for the desired number of second body components 12A, 12B, 12C being utilized. One or more process joints 682 can be created with each of the second body components 12A, 12B, 12C. After the desired number of process joint 682 are created, the components 10, 12A, 12B, 12C are considered to be geometrically set in position relative to one another, and the method 700 can proceed to block 722.

Once all of the process joints 682 are created for the desired number of second body components 12A, 12B, 12C, the structural joint 696 or weld can be formed to affix the first and second body components 10, 12A, 12B, 12C together. The method 700 can include block 722 in which the components 10, 12A, 12B, 12C, as adhered together, are removed from the support 30 and placed on a movable support such as the conveyor 14. Alternatively, the adhered components 10, 12A, 12B, 12C can remain on the support 30 and be moved to the next station to create the structural joint 696.

At block 724 of the method 700, the final structural connections of the components 10, 12A, 12B, 12C are carried out, such as by welding with laser or resistance spot welds. FIG. 4 illustrates that the components 10, 12A, 12B, 12C with process joints 682 can optionally be inspected by scanning with a three-dimensional vision system 126 at a scanning station 202. If the positioning via the process joints 682 are sufficient, the components 10, 12A, 12B, 12C can be moved by another robot 23 from the conveyor 14 to a remote laser welding station 204 where laser welding can be carried out with a remote laser welder.

Specifically, at block 724 of the method 700, the first component 10 and the second component 12A, 12B, 12C are welded together to create the structural joint 696 after creating the process joint 682. As discussed above, the structural joint 696 has the second predetermined strength greater than the first predetermined strength. The structural joint(s) 696 are stronger than the process joint(s) 682 to more permanently affix the first and second body components 10, 12A, 12B, 12C together. The relative position of the first component 10 and the second component 12A, 12B, 12C are maintained without fixtures by the process joint 682 during the welding of the first component 10 and the second component 12A, 12B, 12C together. In certain embodiments, each of the second body components 12A, 12B, 12C are structurally welded to the first component 10 one at a time.

It is to be appreciated that the order or sequence of performing the method 700 as identified in the flowchart of FIG. 37 is for illustrative purposes and other orders or sequences are within the scope of the present disclosure. It is to also be appreciated that the method 700 can include other features not specifically identified in the flowchart of FIG. 37.

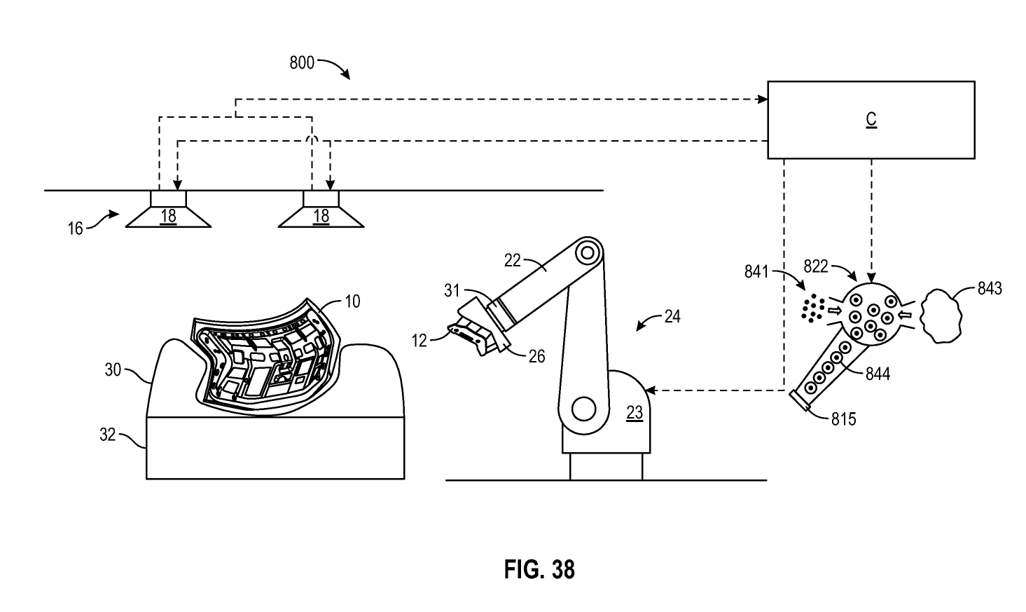

Referring to FIG. 38, a component assembly system 800 is provided. The component assembly system 800 is configured for use in coupling at least two body components, namely a first component 10 and at least one second component 12. As shown in FIG. 38, the component assembly system 800 includes a fixtureless support 30, a vision system 16, a robotic system 24, an applicator system 822, and a controller C.

The first component 10 and the at least one second component 12 may be joined by a process joint 826 (FIGS. 40, 43, 46) after assembly is completed. As discussed herein, assembling the first component 10 and the at least one second component 12 is accomplished without the use of dedicated fixtures or clamps to present, position, or hold the components 10, 12.

The robotic system 24 is configured to pick and move the at least one second component 12 and position the at least one second component 12 relative to the first component 10 based on the first component location result and the second component location result. As such, precision geometry setting of the exact locations of each of the components 10, 12 to be assembled is not required, because the robotic system 24 has been informed of the relative location of the components 10, 12 by the transmission of the first component location result and the second component location result from the controller C to the robotic system 24. Utilizing the first component location result and the second component location result, the robotic system 24 can move and position the at least one second component 12 in the desired orientation relative to the location of the first component 10.

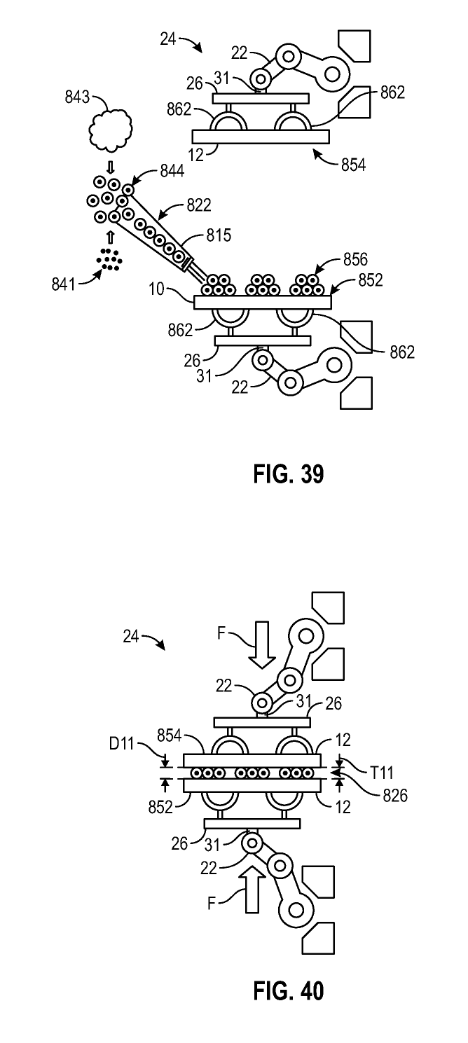

Referring again to FIG. 38, the component assembly system 800 includes an applicator system 822. The applicator system 822 may mix a binder 843 and a plurality of particles 841 to form binder-coated particles 844, which are dispensed therefrom. The particles 841 and binder 843 may be identical to the particles 310 and binder 312 of FIG. 16. The applicator system 822 is configured to dispense binder-coated particles 844 (FIGS. 39-47) of a predetermined size, which is selected based on the material make-up of the first component 10 and the second component 12. The predetermined size of the binder-coated particles 844 dispensed may be governed by the applicator system 822. For example, the applicator system 822 may have an adjustable nozzle 815, which may apply additional binder 843 to a particle 841 dispensed therefrom, which is smaller in size than the predetermined size.

The applicator system 822 may apply the pre-mixed binder-coated particles 844 to at least one of the first component 10 at a first process joint interface 852 and the at least one second component 12 at a second process joint interface 854. The phrase “at least one of” as used herein should be construed to include the non-exclusive logical “or”, i.e., at least one of the first component 10 or the at least one second component 12. In other embodiments, the binder-coated particles 844 may be applied to both the first component 10 at the first process joint interface 852 and the at least one second component 12 at the second process joint interface 854. Simply stated, the binder-coated particles 844 can be applied to either or both of the body components 10, 12 at the respective process joint interfaces 852, 854 prior to relative positioning of the components 10, 12 and formation of the process joint 826.

The process joint 826 may be an initial coupling of the first component 10 and the at least one second component 12 with the binder-coated particles 844 prior to the formation of a structural joint 846 via a laser welding process or the like. The binder 843 and the particles 841 may be formed of any suitable material, which is compatible with the laser welding process. As such, the predetermined strength of the binder-coated particles 844 must be strong enough to hold the at least one second component 12 relative to the first component even if the part fit-up conditions are not perfect or necessarily precise. Thus, the predetermined strength of the binder 843, when set or cured, is sufficient to maintain the at least one second component 12 in a desired position with respect to the first component 10 creating a process joint 826. Cure or set time for the binder 843 is chosen to allow time for the components 10, 12 to be positioned with respect to each other, but quick enough to speed up additive manufacturing procedures, so as to not delay any subsequent procedures at other stations, etc.

Generally, the binder 843 and particles 841 are of a quick-curing material. The binder 843 and the particles 841 may be of the same materials or of different materials. In certain assembly operations, the process joint 826 is cured from 60.0 seconds to about 90 seconds. The binder-coated particles 844 may cure or set utilizing a variety of techniques, e.g., air curing, heat curing, and ultra violet curing.

As an example, the particles 841 may be formed of a magnetic material such as an iron oxide embedded into a ceramic silica matrix. Alternatively, the particles 841 may be formed of another suitable non-magnetic material. The binder 843 may be any suitable binding material that is compatible with the laser-welding process and maintains adherent and non-migratory characteristics. For example, the binder 843 may be polymer based, organic based, or ceramic based. The binder 843 may also be a suitable adhesive.

The process joint 826 is formed when the robotic system 24 couples the first component 10 with the at least one second component 12 at the first process joint interface 852 and the second process joint interface 854, such that the coupling of the first component 10 with the at least one second component 12 causes the binder-coated particles 844 to be in contact with each of and disposed between the first process joint interface 852 and the second process joint interface 854 and causes the binder-coated particles 844 to be cured or set.

The vision system 16 can be utilized to locate the first process joint interface 852 and the second process joint interface 854, such that the applicator system 822 may apply the binder-coated particles 844 to the desired location on the first component 10 and/or the at least one second component 12. Therefore, the vision system 16, such as the cameras 18 or a coordinate locator, can be used to find first process joint interface 852 and/or the second process joint interface 854. The pre-mixed binder-coated particles 844 may be dispensed and applied to the respective first process joint interface 852 and second process joint interface 854 in many different ways, some of which are discussed below.

In one embodiment, the applicator system 822 can include a dispenser, such as a brush, a nozzle, a glue gun, a glue bottle, etc., which is utilized by the robot 23 to apply the binder-coated particles 844 to at least one of the first process joint interface 852 and the second process joint interface 854. The dispenser can be stationary such that the robot 23 moves one of the body components 10, 12 relative to the dispenser. Alternatively, the robot 23 moves the dispenser relative to the respective body component 10, 12. In yet, another application, the binder-coated particles 844 may be applied with the applicator by hand via a worker or operator. In other words, the binder-coated particles 844 may be manually applied by the worker.

The binder-coated particles 844 may be applied in a variety of configurations (FIGS. 39-47) to facilitate the formation of the desired process joint 826. In one example embodiment, shown in FIGS. 39-41, the binder-coated particles 844 are utilized and applied for the purposes of geometric setting and laser welding gap control. In such an embodiment, the applicator system 822 and the robotic system 24 apply a single layer 856 of the binder-coated particles 844 to one of the first process joint interface 852 and the second process joint interface 854, as shown in FIG. 39.

As shown in FIG. 40, the robotic system 24 couples the first component 10 and the at least one second component 12 at the first process joint interface 852 and the second process joint interface 854, with assistance from the vision system 16. The force sensor 31 measures an amount of force applied to at least one of the first component 10 and the at least one second component 12 when adhering the first and second body components 10, 12 together. In other words, the force sensor 31 measures the load applied to at least one of the first component 10 and the second component 12. The force sensor 31 can minimize undesirable deformation of the first and/or second body components 10, 12. Furthermore, the force sensor 31 can provide data to ensure that the desired binder-coated particle 844 contact occurs between the first and second body components 10, 12 at the first process joint interface 852 and the second process joint interface 854.

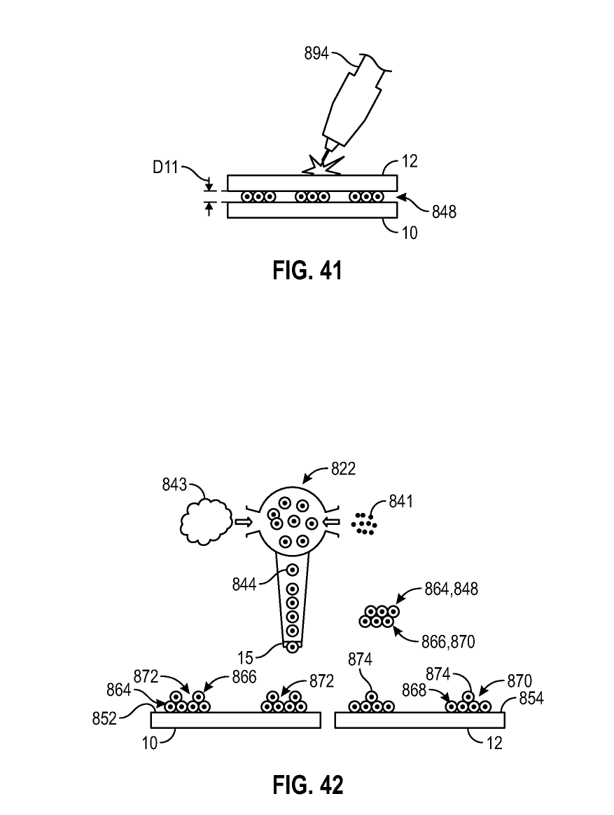

As shown in FIGS. 40-41, in this example, the single layer 856 of binder-coated particles 844 have a thickness T11, which establishes a standoff distance D11 required for laser welding. Resultantly, the single layer 856 of binder-coated particles 844 cures to couple the first component 10 and the at least one second component 12, forming a process joint 826, which maintains the required standoff distance D11 for laser welding (FIG. 41). For example, laser welding of zinc coated steels may have improved quality with reduced porosity when the materials have a standoff distance D11 of around 0.3 mm between them in the area of the weld. This standoff distance D11 may improve weld quality by allowing welding gasses to escape from the welded area prior to solidification. In some cases, the standoff distance should be minimized. For example laser welding of aluminum to aluminum should be done with a standoff distance less than about 0.125 mm in the area of the weld. During the laser welding procedure and the formation of the structural joint 848, the binder-coated particles 844 present between the first component 10 and the second component 12 utilized to maintain the standoff distance D11. During the formation of the structural joint 848, the binder-coated particles 844 may dissolve, dissipate, sublimate, or evaporate. For example, the particles 841 may dissolve into the binder 843.

In another example embodiment, shown in FIGS. 42-44, the binder-coated particles 844 are utilized and applied for the purposes of self-location in geometric setting and laser welding gap control. In such an embodiment, the applicator system 822 and the robotic system 24 apply at least one layer 864, 866, 868, 870 of binder-coated particles 844 to each of the first process joint interface 852 and the second process joint interface 854, as shown in FIG. 42.

Specifically, in the example shown in FIG. 42, the applicator system 822 and robotic system 24 apply a first layer 864, 868 of binder-coated particles 844 and a second layer 866, 870 of binder-coated particles 844 to each of the first process joint interface 852 and the second process joint interface 854. The first layer 864 of binder-coated particles 844 applied to the first process joint interface 852 are placed in contact with the first process joint interface 852. The second layer 866 of binder-coated particles 844 applied to the first process joint interface 852 are applied and intermittently placed atop and between the binder-coated particles 844 of the first layer 864. The binder-coated particles 844 of the first layer 864 and the second layer 866 are applied so as to define a plurality of particle cavities 872 along the first process joint interface 852. The formation of the binder-coated particles 844 may be maintained by one of the magnetic properties of the particles 841, if magnetic, and the adherent characteristics of the binder 841, or other suitable means.

The first layer 868 of binder-coated particles 844 applied to the second process joint interface 854 are placed in contact with the second process joint interface 854. The second layer 870 of binder-coated particles 844 is applied to the second process joint interface 854 and intermittently placed atop and between the binder-coated particles 844 of the first layer 868. The binder-coated particles 844 of the first layer 868 and the second layer 870 are applied so as to define a plurality of particle posts 874 along the second process joint interface 854.

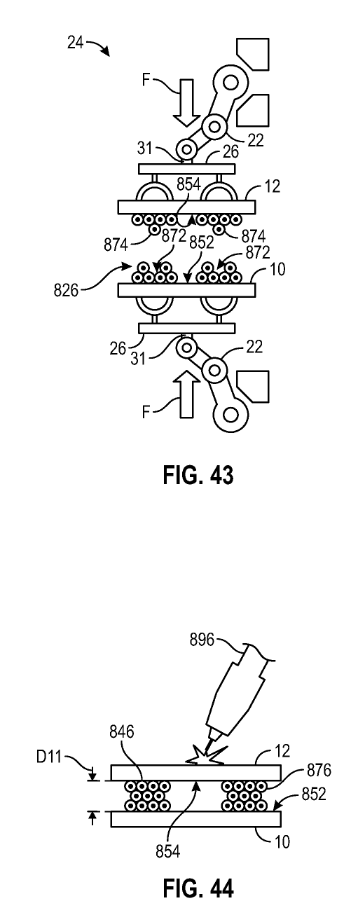

As shown in FIG. 43, the robotic system 24 couples the first component 10 and the at least one second component 12 at the first process joint interface 852 and the second process joint interface 854, with assistance from the vision system 16. The force sensor 31 measures an amount of force F applied to at least one of the first component 10 and the at least one second component 12 when adhering the first and second body components 10, 12 together. In other words, the force sensor 31 measures the load applied to at least one of the first component 10 and the second component 12. The force sensor 31 can minimize undesirable deformation of the first and/or second body components 10, 12. Furthermore, the force sensor 31 can provide data to ensure that the desired binder-coated particle 844 contact occurs between the first and second body components 10, 12 at the first process joint interface 852 and the second process joint interface 854. When the first process joint interface 852 and second process joint interface 854 are coupled to form the process joint 826, each particle cavity 872 is configured to receive one of the plurality of particle posts 874 forming an integration 876 therebetween. The plurality of cavities 872 and the plurality of posts 874 may be a pair of mating features, the integration 876 of which assists in accurately aligning the first component 10 and the second component 12 relative to one another, via the principle of elastic averaging, as the first component 10 and second component 12 are coupled.

As shown in FIG. 44, in this example, the integration 876 of the plurality of particle cavities 872 and the plurality of particles posts 874 defines and maintains the standoff distance D11 required for laser welding. Resultantly, the multiple layers 864, 866, 868, 870 of binder-coated particles 844 cure to couple the first component 10 and the at least one second component 12, forming a process joint 826, which maintains the required standoff distance D11 for laser welding (FIG. 44). For example, laser welding of zinc coated steels may have improved quality with reduced porosity when the materials have a standoff distance D11 of around 0.3 mm between them in the area of the weld. This standoff distance D11 may improve weld quality by allowing welding gasses to escape from the welded area prior to solidification. In some cases, the standoff distance should be minimized. For example laser welding of aluminum to aluminum should be done with a standoff distance less than about 0.125 mm in the area of the weld. During the laser welding procedure and the formation of the structural joint 848, the binder-coated particles 844 present between the first component 10 and the second component 12 utilized to maintain the standoff distance D11. During the formation of the structural joint 848, the binder-coated particles 844 may dissolve, dissipate, sublimate, or evaporate. For example, the particles 841 may dissolve into the binder 843.

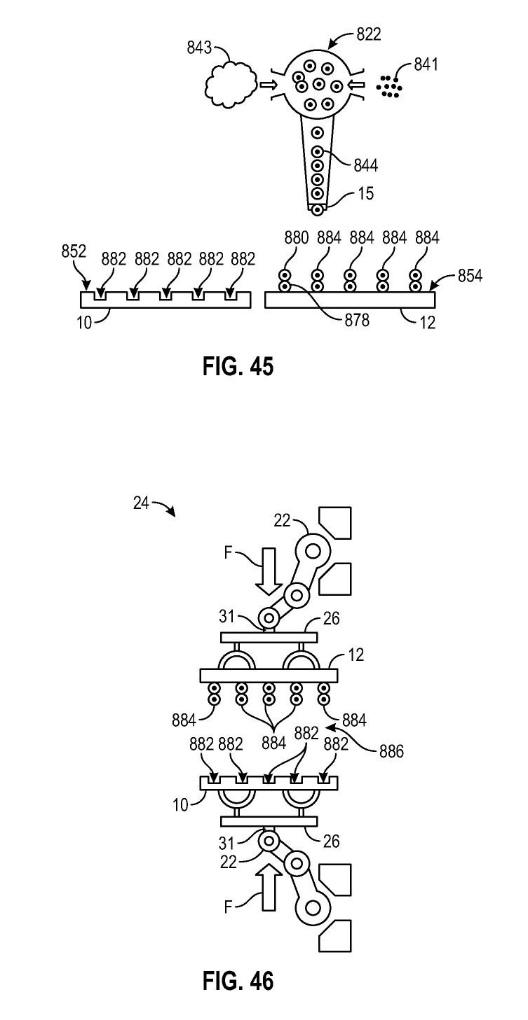

In another example embodiment, shown in FIGS. 45-47, the binder-coated particles 844 are utilized and applied for the purposes of self-location in geometric setting and laser welding gap control, wherein one of the body components 10, 12 has an irregular process joint interface 852, 854. In such an embodiment, the applicator system 822 and the robotic system 24 apply multiple layers 878, 880 of binder-coated particles 844 to the second process joint interface 854, as shown in FIG. 45.

Specifically, in the example shown in FIG. 45, the first process joint interface 852 defines a plurality of machined trenches 882 therealong. As such, the applicator system 822 and robotic system 24 apply at least a first layer 878 and a second layer 880 of binder-coated particles 844 to the second process joint interface 854. The binder-coated particles 844 of the first layer 878 are intermittently spaced along the second process joint interface 854. The binder-coated particles 844 of the second layer 880 are intermittently spaced apart and placed directly atop the binder-coated particles 844 of the first layer 878. In such a configuration, the first layer 878 and second layer 880 form a plurality of binder-coated particle columns 884 spaced apart from one another along the second process joint interface 854. The formation of the binder-coated particles 844 may be maintained by one of the magnetic properties of the particles 841, if magnetic, and the adherent characteristics of the binder 843, or other suitable means.

As shown in FIG. 41, the robotic system 24 couples the first component 10 and the at least one second component 12 at the first process joint interface 852 and the second process joint interface 854, with assistance from the vision system 16. The force sensor 31 measures an amount of force F applied to at least one of the first component 10 and the at least one second component 12 when adhering the first and second body components 10, 12 together. In other words, the force sensor 31 measures the load applied to at least one of the first component 10 and the second component 12. The force sensor 31 can minimize undesirable deformation of the first and/or second body components 10, 12. Furthermore, the force sensor 31 can provide data to ensure that the desired binder-coated particle 844 contact occurs between the first and second body components 10, 12 at the first process joint interface 852 and the second process joint interface 854. When the first process joint interface 852 and second process joint interface 854 are coupled to form the process joint 826, each of the respective trenches 882 defined by the first process joint interface 852 are configured to receive one of the plurality of columns 884 formed by the binder-coated particles 844 applied to the second process joint interface 854. When each of the respective tranches 882 receives one of the respective columns 884, a connection 886 is created therebetween.

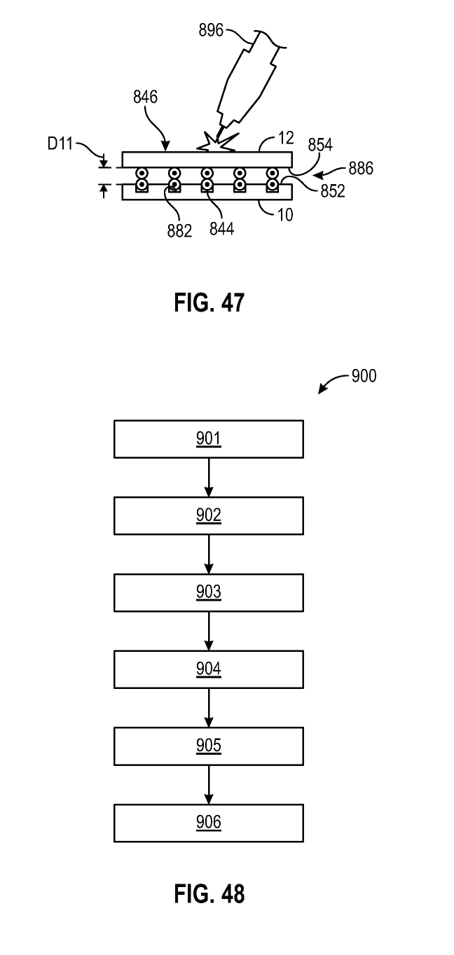

As shown in FIG. 47, in this example, the connection 886 of the plurality of trenches 882 and the plurality of particle columns 884 defines and maintains the standoff distance D11 required for laser welding. Resultantly, the multiple layers 878, 880 of binder-coated particles 844 cure to couple the first component 10 and the at least one second component 12, forming a process joint 826, which maintains the required standoff distance D11 for laser welding (FIG. 47). For example, laser welding of zinc coated steels may have improved quality with reduced porosity when the materials have a standoff distance D11 of around 0.3 mm between them in the area of the weld. This standoff distance D11 may improve weld quality by allowing welding gasses to escape from the welded area prior to solidification. In some cases, the standoff distance should be minimized. For example laser welding of aluminum to aluminum should be done with a standoff distance less than about 0.125 mm in the area of the weld. During the laser welding procedure and the formation of the structural joint 848, the binder-coated particles 844 present between the first component 10 and the second component 12 utilized to maintain the standoff distance D11. During the formation of the structural joint 848, the binder-coated particles 844 may dissolve, dissipate, sublimate, or evaporate. For example, the particles 841 may dissolve into the binder 843.

A process joint 826 formed by each of the above-mentioned application strategies has a first predetermined strength that maintains the at least one second component 12 relative to the first component 10. Accordingly the structural joint 848 has a second predetermined strength, which is greater than the first predetermined strength. The process joint 826 alone is designed to maintain the first component 10 and the at least one second component 12 relative to one another without fixtures during the formation of a structural joint 846. By utilizing binder-coated particles 844 to form the process joint 826 and secure or attach the at least one second component 12 to the first component 10 eliminates obstructions which can occur with fixtures or clamps. Furthermore, eliminating obstructions can improve cycle times and is useful for laser welding applications. The binder-coated particles 844 establish a standoff distance D11 between the first component 10 and the at least one second component 12 required for laser welding operations, and wherein the standoff distance D11 correlates with the placement of the subsequent structural joint 848 that rigidly affixes the first component 10 and the at least one second component 12.

The controller C is in communication with each of the vision system 16, the robotic system 24, and the applicator system 822. The controller C has a processor and tangible, non-transitory memory on which is recorded instructions, such that execution of the recorded instructions cause the processor to execute the method 900 detailed in FIG. 48. The controller C is configured to execute the instructions from the memory, via the processor. Generally, execution of the recorded instructions causes the controller C to communicate with each of the vision system 16, robotic system 24, and the applicator system 822 to couple the first component 10 and second component 12 based on the first component location result and the second component location result to thereby form a process joint 826 having a first predetermined strength that maintains the second component relative 12 to the first component 10. Specifically, execution of the recorded instructions causes the processor to execute the steps of the present method 900 of assembling a plurality of body components, detailed in FIG. 48.

At block 901, the processor causes the controller C to signal the vision system 16 to determine the location of a first component 10 on a fixtureless support 30. Upon locating the first component 10, the vision system 16 returns a first component location result to the controller C.

At block 902, the processor causes the controller C to signal the vision system 16 to determine the location of the second component 12. Upon locating the second component 12, the vision system 16 returns a second component location result to the controller C.

At block 903, the processor causes the controller C to command the applicator system 822 to apply the pre-mixed binder-coated particles 844 to at least one of the first component 10 at a first process joint interface 52 and the second component 12 at a second process joint interface 854. The binder-coated particles 844 may be applied as discussed herein above with respect to FIGS. 39-47.

At block 904, the processor causes the controller C to command the robotic system 24 to position the second component 12 relative to the first component 10 based on the first component location result returned by the vision system 16. Again, with regard to the second component 12, the at least one second component 12 is moved by the at least one robotic arm 22 of the at least one vision-guided robot 23. In any of the embodiments, the camera(s) 18 are in communication with the controller C that also controls one or more robots 23 of the robotic system 24. Based on the first component location result and the second component location result received by the controller C from the vision system 16, namely the cameras 18, the controller C then provides a control signal, which commands the robotic system 24 to position the components 10, 12 with respect to one another, which as such, actuates robotic arm(s) 22 of the one or more robot(s) 23.

At block 905, the processor causes the controller C to command the robotic system 24 to couple the first component 10 and the second component 12 at the first process joint interface 852 and the second process joint interface 854 to create a process joint 826 having a first predetermined strength that maintains the second component 12 relative to the first body component 12. As indicated in FIG. 38, the first component 10 can be held on the fixtureless support 30 while the process joint is made, or, as shown in FIGS. 39-40, the first component 10 and the second component 12 can both be supported by separate fixtureless supports in the form of robotic arms 22 with end effectors 26 during creation of the process joint 826.

The robotic system 24 can include a force sensor 31 (FIG. 39) in communication with the controller C to measure an amount of force applied to at least one of the first component 10 and the second component 12 when adhering the first and second body components 10, 12 together with the binder-coated particles 844. In other words, the force sensor 31 measures the load applied to at least one of the first component 10 and the second component 12. The force sensor 31 monitors the clamping force F present during the formation of the process joint 826, to ensure that the desired application force acts on the binder-coated particles 844 without causing deformation of the components 10, 12. The force sensor 31 can minimize undesirable deformation of the first and/or second body components 10, 12. Furthermore, the force sensor 31 can provide data to ensure that the desired contact occurs between the first process joint interface 852, the second process joint interface 854, and the binder-coated particles 844 during the formation of the process joint 826 and to ensure the desired standoff distance D11 of the process joint 26. It is to be appreciated that one or more force sensors 31 can be utilized and the force sensor(s) 31 can be any suitable location. Generally, the force sensor 31 can be disposed on the end effector 26.

As discussed above, the process joint 826 is provided to maintain a desired position of the second component 12 relative to the first component 10. In other words, the process joint 826 is the mechanism by which the first component 10 and any of the second body components 10 are held relative to one another prior to establishing of one or more structural joints 848. The process joint 882 thus serves as the geography setting feature of the first component 10 and the second component 12 prior to creating the structural joints 848.

In all embodiments, if there is contact between the components 10, 12 during formation of the process joint 826, either direct contact or indirect contact through the binder-coated particles 844, the controller C can control the robotic arm 22 to allow movement in a plane perpendicular to the force F (e.g., in an X-Y plane if the force is in a Z direction), thereby allowing force control to take precedence over positional information when creating the process joint 826.

At block 906, the processor causes the controller C to command a welding apparatus 896 to weld the first component 10 to the second component 12 at the process joint 826 to form a structural joint 848 of a second predetermined strength, which is greater than the first predetermined strength of the process joint 826. The structural joint 848 provides a permanent attachment between the body components 10, 12. The structural joint 848 can be formed by laser welding, resistance spot welding, other fusion bonding or welding (e.g. metal inert gas (MIG) weld), solid state bonding (e.g. ultrasonic weld or friction stir weld), a mechanical joint (e.g. rivet, flow drill screw or mechanical clinching), or a hybrid method of the above (combinations of one or more of the above methods) which is configured to hold the first and second body components 10, 12 to one another throughout the useful life of the assembly when installed on a vehicle.

The structural joint 848 or weld can be in any suitable location relative to the process joint 826. In some instances, the structural joint 848 can be formed away from the process joint 826. In other instances, the structural joint 848 can be formed proximal or near the process joint 826. In yet other instances, the structural joint 848 can be formed over the process joint 826.

The assembly system 200 and the method 900 can reduce production costs and lead time to introduce new vehicle models because dedicated fixtures and clamps for different stages of the assembly are not required. Complex part holding pallets and fixtures are not required as the vision system 16 enables retrieval and placement of the first component 10 and the second component 12 without requiring precise initial placement thereof. Additionally, many of the fixtureless supports 30 and end effectors 26 disclosed herein are reconfigurable, flexible and thus, rapid reconfiguration for use with different subassemblies is enabled.

It is to be appreciated that the order or sequence of performing the method 900 as identified in the flowchart of FIG. 48 is for illustrative purposes and other orders or sequences are within the scope of the present disclosure. It is to also be appreciated that the method 900 can include other features not specifically identified in the flowchart of FIG. 48.

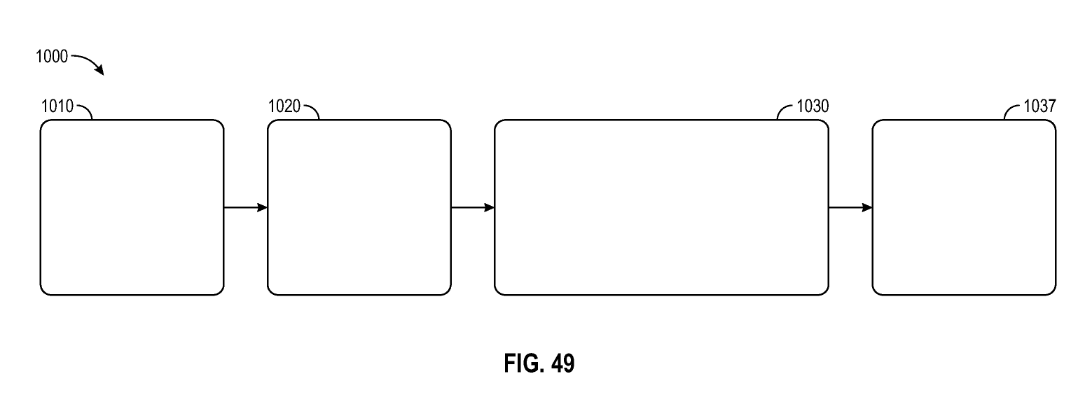

FIG. 49 shows a flow diagram of the method of assembly 1000 of vehicle body components, and includes block 1010, in which a robot picks and places the first component 10 from an unfixtured position, such as on a standard flat belt conveyor, in a storage bin, or in a shipping rack. Based on the information received from the cameras 18, the controller C then provides a control signal that actuates robotic arm(s) 22 of the one or more robot(s) used in the method 1000.

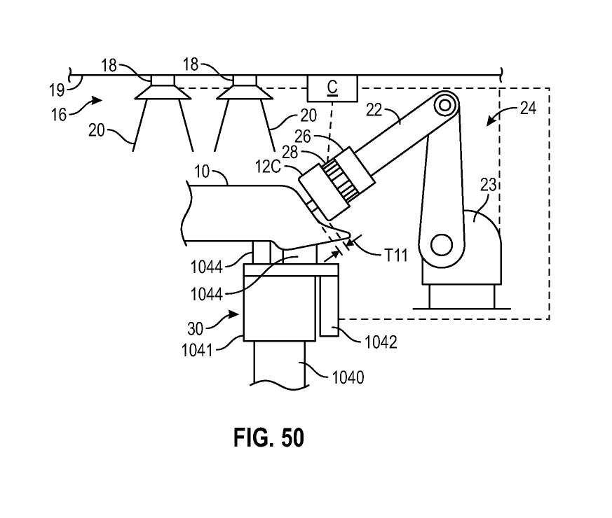

Referring to FIGS. 49 and 50, in block 1020 of the method 1000, the first component 10 is placed on a fixtureless support 30 by the robotic system 24, as shown in FIG. 50. In FIG. 50, the support 30 includes a servo motor 1040 that moves a base 1041 in a linear Z direction (i.e., up and down as viewed in FIG. 50). An actuator 1042 can separately move adjustable and lockable pins 1044 to conform to the outer surface of the first component 10, thus functioning as a reconfigurable support.

Once the first component 10 is positioned on the support 30, block 1020 continues by using the vision system 16 to determine the location of the first component 10 on the support and the location(s) of the second vehicle body component(s) 12A, 12B, 12C. The method 1000 is designed so that the second vehicle body components 12A, 12B, 12C are those that are smaller in size than the first component 10. Additionally, the first component 10 is arranged on the fixture 30 between the components 12A, 12B, 12C, as indicated with respect to component 12C in FIGS. 50-52, to enable open and flexible access to the components by the robot 23.

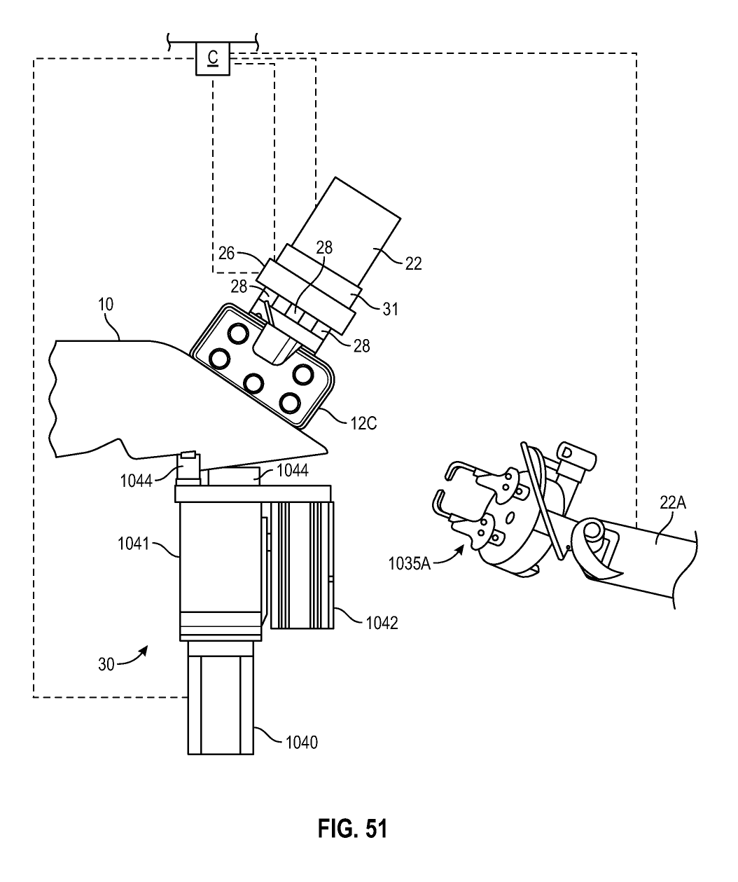

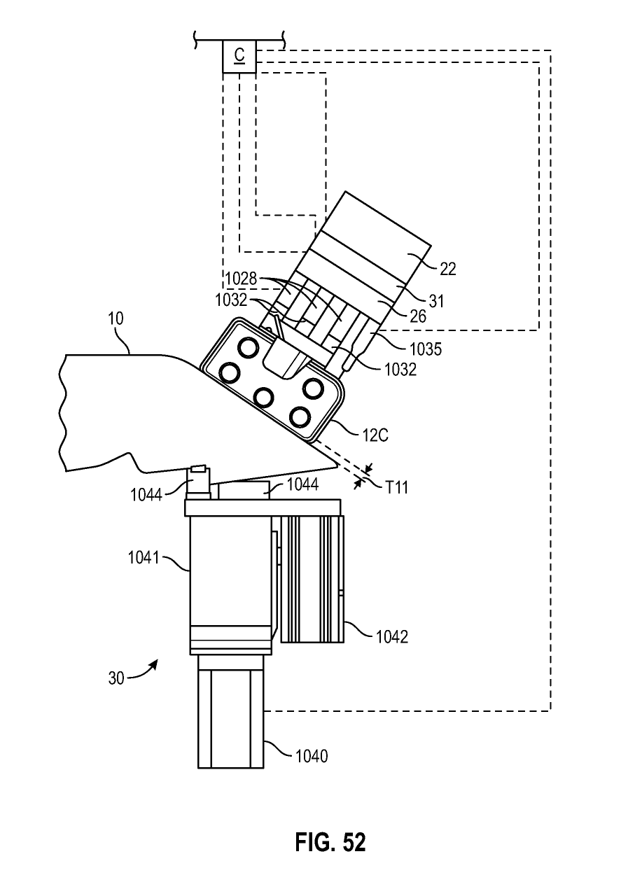

The method 1000 then proceeds to block 1030 in which a process joint is provided to maintain a desired relative position of the second component 12A, 12B, or 12C to the first component 10. In other words, the process joint is the mechanism by which the first component 10 and any of the second vehicle body components 12A, 12B, 12C are held relative to one another prior to establishment of one or more final structural joints. The support 30 supports one side of the vehicle body component 10, and the second vehicle body component, shown as 12C in FIG. 50, is held in place using the end effector 26 of the robot 23. The components 10, 12C may be held at a predetermined standoff distance T11 if laser welding is subsequently used to provide the structural joints. Alternatively, if resistance spot welding is to be used to provide the structural joints, then in some embodiments the end effector 26 may ensure contact between the first component 10 and the second component 12C, as shown and described with respect to FIG. 51. The robotically held process joint eliminates the need for clamps to hold the components 10, 12C to one another during a subsequent laser welding or resistance spot welding operation. A welder such as shown in FIGS. 51-52 is also included in the system of FIG. 50.

In embodiments in which the second component 12C contacts the first component 10, such as when resistance spot welding is to be carried out, the force of application of the second component 12C onto the first component 10 may be controlled by integrating the force sensor 31 at the end effector 26 on the robotic arm 22. As shown in FIG. 51, the force sensor 31 is operatively connected to the controller C and is controlled to ensure that the force applied by the end effector 26 to create the process joint maintains a predetermined value to ensure secure part contact for subsequent structural jointing process or below a threshold to prevent deformation of the components 10, 12C. In all embodiments, if there is operative contact between the components 10, 12C during formation of the process joint, the controller C can control the robotic arm 22 to allow movement in a plane perpendicular to the force (e.g., in an X-Y plane if the force is in a Z direction), thereby allowing force control to take precedence over positional information when establishing the process joint. In this manner locating and holding of the components 10, 12A, 12B, 12C is integrated in a hybrid control of robot arm motion and force. The process joint created by force-controlled contact between the first component 10 and the second component 12C enables another robotic arm 22A to control a resistance spot welder 1035A to create structural welds of the components 10, 12C to one another. The vision system 16 of FIG. 50, or a robot-mounted vision system would also be included with the system of FIG. 51.

FIG. 52 shows an embodiment of a system having an end effector 26 that integrates adjustable locating pins 1028, which may be separately controlled in length to provide an adjustable interface to mate with the outer surface of the component 12C. Magnets 1032 may be attached at the end of each of the pins 1028. Additionally, a laser weld gun 1035 is integrated in the end effector 26 and is movable thereon. A force sensor 31 is also integrated into the end effector 26.

With reference to FIG. 49, after the process joint is established in block 1030 between each of the components 12A, 12B, 12C and the component 10, and the components 12A, 12B, 12C are welded to the component 10, the components 10, 12A, 12B, 12C are considered to be geometrically set in position relative to one another, and the method 1000 proceeds to block 1037. The component 10 can be removed from the support 30 and moved to a separate welding cell, or can remain supported on the support 30, such that the re-spot process is carried out in the same cell as the geo-spot process. In block 1037, the final structural connections of the assembly are carried out, such as by welding with laser or resistance spot welds. For example, laser welding can be carried out with a remote laser welder having an end effector 26B with a vision system and mirror system 37 as shown and described in FIG. 17. After welding, additional processing may occur, such as by dispensing adhesives material to the jointed first and second vehicle body components 10, 12A, 12B, 12C (i.e., the assembled inner deck lid panel). A robot 23, a vision system 16, and a flexible end effector 26 can be cooperatively controlled by the controller C to enable quick application of the adhesive. The adhered components can then be inspected at a scanning station for conformance with predetermined positioning specifications with a three-dimensional vision system 126. If positioning via the adhesive is sufficient, the assembly can be moved by another robot to one or more additional processing stations, such as for hemming an outer deck panel with the assembled inner deck lid panel.

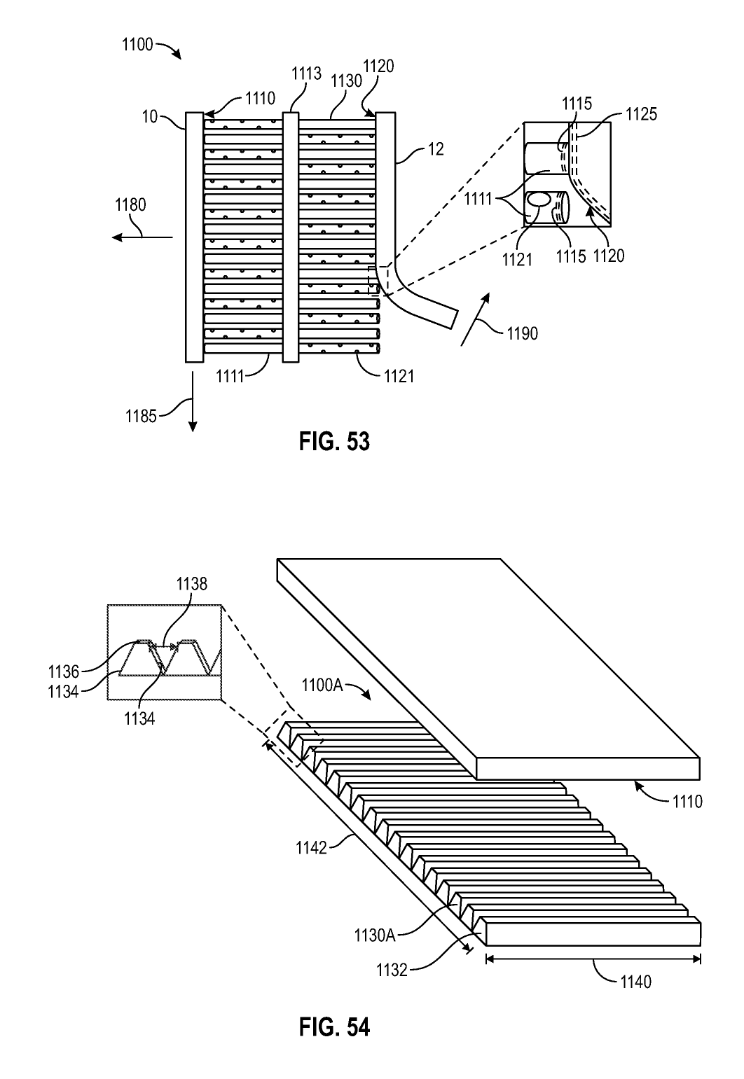

FIG. 53 illustrates a releasable adhesive 1100, which allows reversible bonding through the use of van der Waals force. The releasable adhesive 1100 adheres and releases from a first surface 1110 and a second surface 1120 that are substantially solid surfaces made of various materials and having various textures. For example, the first surface 1110 may be a surface of the first component 10, and the second surface 1120 may be a surface of the second component 12.

The releasable adhesive 1100 comprises a primary material 1111 that has particles (e.g., molecules, atoms, ions) arranged to be in contact with particles on the first surface 1110, and on the second surface 1120. As seen in the callout of FIG. 53, molecules 1115 of the primary material 1111 are in contact with molecules 1125 of the second surface 1120, at a location of attachment. For example, a surface of the primary material 1111 is generally parallel with the first surface 1110, and another surface of the primary material 1111 is generally parallel with the second surface 1120. Van der Waals force allows the molecules 1115 of the primary material 1111 to adhere to the second surface 1120. Specifically, the molecules 1115 of the primary material 1111 maintain a bond between the releasable adhesive 1100 and an attaching surface (e.g., the second surface 1120) against pull forces 1180 and shear forces 1185.

Unlike a traditional chemical bonding process required by typical adhesives, the releasable adhesive 1100 does not require curing, thus allowing the releasable adhesive 1100 to adhere to the surfaces 1110, 1120 almost instantaneously. The releasable adhesive 1100 can also adhere to the surface 1110, 1120 without use of an external power supply, actuator, or otherwise.

Van der Waals force also allows the bond between the molecules 1115 of the primary material 1111 and the molecules of the attaching surface (e.g., the molecules 1125 of the second surface 1120) to detach when peel forces 1190 are applied to the surfaces attaching surface or the releasable adhesive 1100. As seen in the callout of FIG. 53, where the primary material 1111 is not in contact with to the second surface 1120, the surface of the primary material 1111 contacting the molecules 1115 is not generally parallel with the second surface 1120 contacting the molecules 1125.

In some embodiments, the primary material 1111 includes a microstructured and/or a nanostructured polymer, such as silicone and polydimethylsiloxane (PDMS), among others. In some embodiments, the primary material 1111 includes polymers such as (functionalized) polycarbonate, polyolefin (e.g., polyethylene and polypropylene), polyamide (e.g., nylons), polyacrylate, acrylonitrile butadiene styrene.

In some embodiments, the primary material 1111 includes composites such as reinforced plastics where the plastics may include any of the exemplary polymers listed above, and the reinforcement may include one or more of the following: clay, glass, carbon, polymer in the form of particulate, fibers (e.g., nano, short, or long fibers), platelets (e.g., nano- sized or micron-sized platelets), and whiskers, among others.

The primary material 1111 can include synthetic or inorganic, molecules. While use of so-called biopolymers (or, green polymers) is becoming popular in many industries, petroleum based polymers are still much more common in everyday use. The primary material 1111 may also include recycled material, such as a polybutylene terephthalate (PBT) polymer, being, e.g., about eighty-five percent post-consumer polyethylene terephthalate (PET). In one embodiment, the primary material 1111 includes some sort of plastic. In one embodiment, the material includes a thermoplastic.

In one embodiment the primary material 1111 includes a composite. For example, the primary material 1111 can include a fiber-reinforced polymer (FRP) composite, such as a carbon-fiber-reinforced polymer (CFRP), or a glass-fiber-reinforced polymer (GFRP). The composite may be a fiberglass composite, for instance. In one embodiment, the FRP composite is a hybrid plastic-metal composite (e.g., plastic composite containing metal reinforcing fibers). The primary material 1111 in some implementations includes a polyamide-grade polymer, which can be referred to generally as a polyamide. In one embodiment, the primary material 1111 includes acrylonitrile-butadiene-styrene (ABS).

In one embodiment, the primary material 1111 includes a polycarbonate (PC). The primary material 1111 may also comprise a type of resin. Example resins include a fiberglass reinforced polypropylene (PP) resin, a PC/PBT resin, and a PC/ABS resin.

In the embodiment shown in FIG. 53, the releasable adhesive 1100 comprises a plurality of setae 1130 (e.g., synthetic setae). Van der Waals force allows the primary material 1111 within/on each setae 1130 to adhere and release to the surfaces 1110, 1120 using attractions and repulsions between particles (e.g., atoms, molecules, ions) of the primary material 1111 and the surfaces 1110, 1120. The setae 1130 extend from both sides of a base 1113 which allows the releasable adhesive 1100 to function as a double-sided adhesive.

As described above, van der Waals force allows the molecules 1115 of the primary material 1111 to attach and detach from the molecules of the attaching surface (e.g., the molecules 1125 of the second surface 1120), depending on the orientation of the molecules 1115 of the primary material 1111 and the molecules of the attaching surface. Specifically, the van der Waals force allows the primary material 1111 within or on the setae 1130 to attach to and peel away from the surfaces 1110, 1120 to reverse (release) the bond formed between the primary material 1111 within/on the setae 1130 and the surfaces 1110, 1120.

Impurities on or in the surfaces 1110, 1120, such as dirt, oil, and air pockets, do not substantially weaken the overall bond formed by the releasable adhesive 1100 because of the many areas of contact between the setae 1130 and the surface 1110, 1120. Specifically, the setae 1130 form a plurality of independent bonds with the surface 1110, 1120, which allows the releasable adhesive 1100 to bond even with the existence of some impurities affecting the bond at one or more limited points of interface.

The releasable adhesive 1100, including each setae 1130, may be designed to have a predetermined load-bearing capability. For example, where a load to be bore is from a small object under tension loading, the load bearing capability of the releasable adhesive 1100 may be between about 0.1 pounds of force per square centimeter (lbs/cm²) and about 1.0 lb/cm², wherein the area measurement (cm²) is the surface area of the primary material 1111 within/on each setae 1130. However, where the object is under shear loading, the load bearing capability of the releasable adhesive 1100 may be between about 1.0 and about 20 lbs/cm².

In some embodiments, as also shown in FIG. 53, the primary material 1111 is infused with an embedded material 1121. Alternatively, the embedded material 1121 may be a material with different properties than the primary material 1111.

The embedded material 1121 can include particles or pathways infused into a molecular structure of the primary material 1111. The embedded material 1121 may be infused into each of the setae 1130 within the primary material 1111. Alternatively, the embedded material 1121 may be infused into selected setae 1130, shown in FIG. 53.

In some embodiments, the embedded material 1121 may be used to increase conductivity of the primary material 1111. For example, doping (e.g., varying placement of any number of electrons and holes within a molecular structure) can be used to increase conductivity of the primary material 1111. Increasing conductivity of the primary material, and thus releasable adhesive 1100, may be important in applications where the surfaces 1110, 1120 need to conduct electricity. For example, doping of the primary material 1111 may be suitable in an application where the releasable adhesive 1100 serves as a conductor within a battery application.

The embedded material 1120 can include conductive fillers such as, but not limited to, carbon nanotubes, carbon black, metal nanoparticles (e.g., copper, silver, and gold), or combination thereof.

In another embodiment of releasable adhesive 1100A, seen in FIG. 54, the setae 1130A are formed into an array of truncated prisms 1132. Each truncated prism 1132 includes at least one side 1134 and a top 1136 (seen in the callout of FIG. 54), which serve as flat, generally flat, or smooth surfaces to maximize contact with an attaching surface (e.g., the first surface 1110). The van der Waals force that can be exerted on the attaching surface is higher with greater contact area, and so maximizing contact with the attaching surface is a priority in design of the adhesive 1100.

In some embodiments the truncated prisms can vary in geometric shape. For example, as seen in FIG. 54, the array of truncated prisms can be formed in the shape of a truncated pyramid, where each pyramid includes two sides 1134 and top 1136 that are used to generate sufficient van der Waals force for adhesion with the surfaces 1110, 1120. However, the array of truncated prisms can be in the form of a truncated cone (e.g., sloping or frustro-conical surface), where the side 1134 extends around a circumference of a circular base.

Impurities on or in the surfaces 1110, 1120, such as dirt, oil, and air pockets, do not substantially weaken the overall bond because of the many areas of contact between the truncated prisms 1132 and the surface 1110, 1120. Specifically, the truncated prisms 1132 form a plurality of independent bonds with the surface 1110, 1120, which allows the releasable adhesive 1100 to bond even with the existence of some impurities affecting the bond at one or more limited points of interface.

The array of truncated prisms 1132 are extended across a defined width 1140. The width 1140 can range approximately between 1 mm and 20 mm. The truncated prisms repeat along a defined length 1142 with a range similar to the width 1140. Spacing between each prism 1132 should be sufficient to allow contact to a surface (e.g., the first surface 1110). For example, a space 1138 between one edge of a first prism 1132 and a subsequent prism 1132 may be between 10 nanometers (nm) and 200 micrometers (um).

In some embodiments, the truncated prisms 1132 may include the embedded material 1121. The embedded material 1121 may be added (e.g., doped) into the microstructure of truncated prisms 1132. By including another array of truncated prisms 1132 extending from a base of the primary material, such as base 1153 of FIG. 53, opposite the array shown in FIG. 54, the releasable adhesive 1100A can function as a double-sided adhesive.

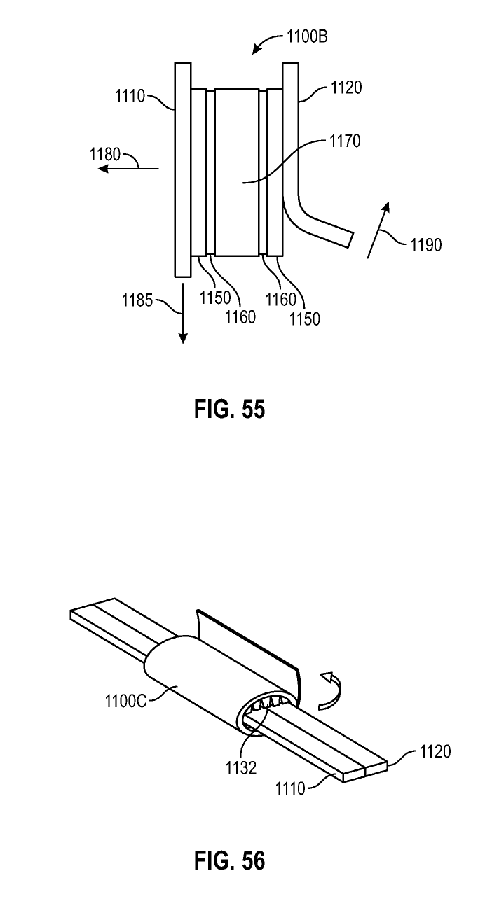

In another embodiment, seen in FIG. 55 a releasable adhesive 1100B may include a plurality of layers including an adhesion pad 1150, a skin 1160, and a tendon 1170. Collectively, the plurality of layers maximize areas of contact with the surfaces 1110, 1120 while maintaining stiffness in a direction of applied loads (e.g., along the fibers of the fabric of the skin 1160).

In this embodiment, the adhesion pad 1150 (e.g., a polymer elastomer) attaches to the skin 1160 (e.g., woven fabric) which is attached to a tendon 1170 (e.g., woven fabric). Attaching the adhesion pad 1150 to the skin 1160 and the tendon 1170 provides strength enabling adhesion to maintain against shear force 1185 and pull force 1180. An example in FIG. 55 illustrates how the first surface 1110 is maintained against shear forces 1185 and pull forces 1180 through stiffness of fabric (e.g., fibers) within the releasable adhesive 1100B. Additionally, the plurality of layers provide stiffness in a direction of peel loading (e.g., peel force 1190), thus enabling release from the attached surface (e.g., the second surface 1120 as seen in FIG. 55).

The adhesion pad 1150 may include materials that behave elastically within a pre- determined force capacity range of a desired application. The materials should ensure deformation losses (e.g., viscoelastic, plastic, or fracture) in the materials of the adhesion pad 1150 are minimized or otherwise reduced. The adhesion pad 1150 may include materials such as, but not limited to, silicone, PDMS, and the like. The adhesion pad 1150 may have a thickness between 10 nm and 100 nm.

The skin 1160 may include similar elastic materials that minimize deformation losses as described in association with the adhesion pad 1150. The skin 1160 may include woven fabric materials such as carbon fiber fabric, fiber glass, KEVLAR® (KEVLAR is a registered trademark of E. I. du Pont de Nemours and Company of Wilmington, Delaware), and the like. The skin 1160 may have a thickness between 10 nm and 1 mm.

The tendon 1170 may include woven fabric materials with high stiffness fibers such as glass fiber, nylon, and carbon-fiber, among others. The tendon 1170 should be of a thickness that sufficiently attaches the pad 1150 to the skin 1160. For example, the tendon 1170 can have a length between 1 mm and 100 mm.

The connection between the tendon 1170 and the adhesion pad 1150 may have pre-defined dimensions, orientation, and spatial location according to particular a desired application. The pre-defined dimension can be altered to balance shear and normal loading requirements for the desired application.

In electrically conductive applications, the pad 1150 can be doped with the embedded material 1121. For example, the embedded material 1121 can include metal nanoparticles as stated above. In some embodiments, the skin 1160 and/or the tendon 1170 can also be doped electrically conductive materials (e.g., carbon fiber fabric).

Where the tendon 1170 attaches to the pad 1150 can affect functionality of the releasable adhesive 1100. Characteristics such as thickness of the tendon 1170, material composition of the tendon 1170, and positioning of tendon 1170 with respect to the pad 1150 can be set in various ways to achieve different results for desired performance in various applications. For example, positioning of the tendon 1170 can affect hanging ability. Attaching the tendon 1170 at an edge of pad 1150 allows increase strength of the releasable adhesive 1100 in the shear direction (i.e., the direction of the shear force 1185), as seen in FIG. 55. However, attaching the tendon 1170 on an inner surface of the pad 1150 allows increased strength of the releasable adhesive 1100 in the pull direction (i.e., the direction of the pull force 1180).

In another embodiment, seen in FIG. 56 the releasable adhesive 1100 (e.g., setae 1130, the prisms 1132) may be formed as a flexible structure that can be molded to surround or otherwise connect surfaces. For example, the releasable adhesive 1100 may function similar to single-sided tape.

In some embodiments, the releasable adhesive 1100, 1100A, 1100B, etc., can be included on more than one surface for purposes of adhesion. For example, the releasable adhesive 1100 and the releasable adhesive 1100B may function as a double-sided tape adhering surface 1110 to surface 1120. The releasable adhesive 1100A and/or 1100C can also be configured to function as double-sided tape by including another array of setae 1130A extending from a base 1113 opposite the setae 1130A shown.

The single-sided or double-sided tape may be used to position between, pinch together, wrap around, or otherwise hold together the surfaces 1110, 1120.

The single-sided or double-sided tape may utilize the releasable adhesive 1100, 1100A, 1100B, 1100C in a non-conductive form or with conductive doping, using the embedded material 1120. For example, the releasable adhesive 1100, 1100A, 1100B, 1100C may be in the form of a conductive, single-sided tape, which may be used to secure the surfaces 1110, 1120 to one another and pass electrical currents through one another and the single-sided tape, as seen in FIG. 56.

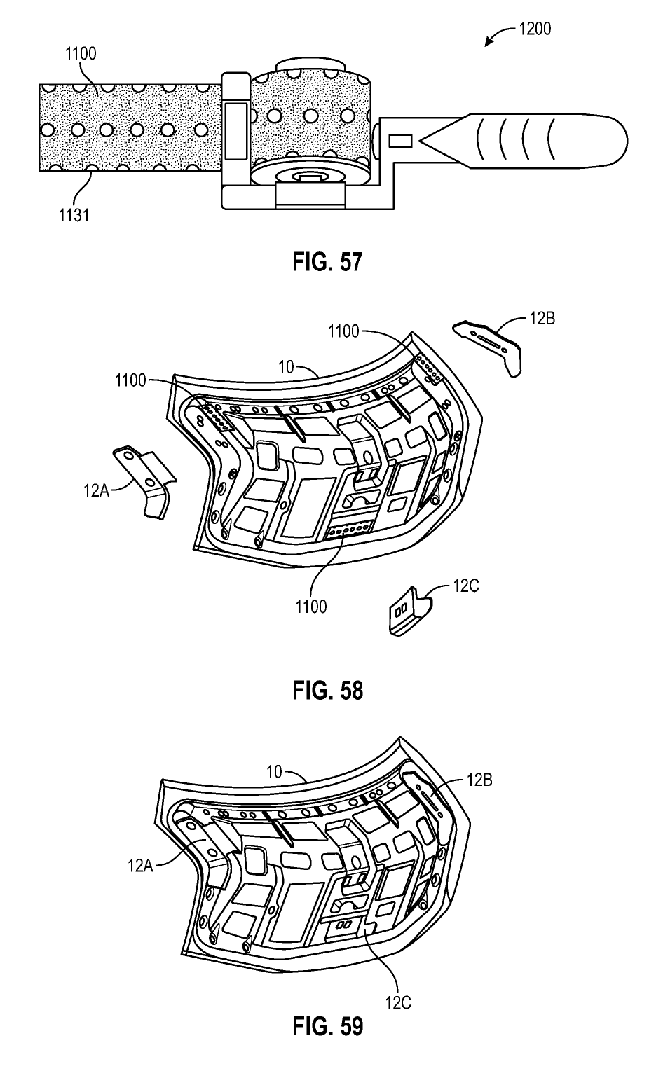

FIG. 57 illustrates a tape dispenser 1200 for applying the releasable adhesive 1100 to a component or subcomponent. Where the first component 10 with the first surface 1110, and the second component 12 with the second surface 1120 need to be temporarily held together prior to a subsequent manufacturing operation, the releasable adhesive 1100 may serve as a process joint, to allow assembly of components and subcomponents without the use of a fixture (fixtureless). The tape dispenser 1200 may be an off-the-shelf dispenser used to apply tape (e.g., single sided) to a surface. The tape dispenser 1200 may alternatively be used to apply the releasable adhesive 1100A, 1100B, or 1100C. Any of the releasable adhesives described herein may be used to establish a process joint.

In some fixtureless embodiments, the releasable adhesive 1100 is a single-sided tape, which can be attached to the first surface 1110 and then looped or otherwise turned to attach to the second surface 1120. In other fixtureless embodiments, the releasable adhesive 1100 is in the form of the double-sided tape described above, which attaches the first surface 1110 to one side of the tape and attaches the second surface 1120 to a second side of the tape.

In some embodiments, as seen in FIG. 57, tape including the releasable adhesive 1100 includes ventilation holes 1131 to allow escape of gases, fumes, and other precipitant during subsequent manufacturing. The ventilation holes 1131 are sized and spaced to allow passage of gases and fumes, while maintaining strength to adhere the first surface 1110 with the second surface 1120. Once the surfaces 1110, 1120 are secured with the releasable adhesive 1100, the surfaces 1110, 1120 can be welded or otherwise permanently joined.

In an embodiment where the releasable adhesive 1100 is in the form of a tape, the thickness of the tape may depend on a desired fit of the surfaces (e.g., whether a standoff distance is desired between the first surface 1110 and the second surface 1120). A close fit (e.g., minimal or no gap) of the surfaces 1110, 1120 may be desired where components are at or near a surface visible to a consumer, whereas a gap may be desired where components are joined at or near a recessed channel or on a surface not visible to the consumer. For example, where a close fit is desired between the surfaces 1110, 1120, the thickness of the releasable adhesive 1100 can be approximately 100 μm. However, where a gap is desired between the surfaces 1110, 1120, the thickness of the releasable adhesive 1100 can be between 200 μm and 2 mm.

FIGS. 58 and 59 illustrate a process of a fixtureless application using the releasable adhesive 1100. As seen, the releasable adhesive 1100, in a double-sided tape form, is used to secure the smaller second components 12A, 12B, 12C to the larger first component 10 to form process joints prior to welding the second components 12A, 12B, 12C to the first component 10.

First, the double-sided tape containing the releasable adhesive 1100 is attached to the first component 10. A dispense of tape can be one continuous length or several smaller segmented pieces to join the first component 10 with second components 12A, 12B, 12C. Continuous length may be desirable where at least one of the surfaces 1110, 1120 (e.g., on either the first component 10 or any of the second components 12A, 12B, 12C) have a large flat area. However, smaller segmented pieces may be desirable where at least one of the surface 1110, 1120 includes curvature.

Next, second components 12A, 12B, 12C are secured to the first component 10 with the releasable adhesive 1100 on the double-sided tape connecting the joining surfaces. The double-sided tape can be removed during a subsequent process or remain after a more permanent joining process (e.g., welding) secures the first component 10 and second components 12A, 12B, 12C.

While the best modes for carrying out the many aspects of the present teachings have been described in detail, those familiar with the art to which these teachings relate will recognize various alternative aspects for practicing the present teachings that are within the scope of the appended claims.

1. A system for assembling a first component and a second component, the system comprising:
a support operatively supporting the first component without any fixtures;
a vision system configured to view the supported first component and the second component and determine the locations thereof;
a robotic system configured to move and position the second component relative to the first component; and
a controller operatively connected to the vision system and to the robotic system and operable to control the robotic system to position the second component relative to the first component based on the locations determined by the vision system.

2. The system of claim 1, wherein the first component has a first feature, and the second component has a second feature complementary to the first feature such that the first feature and the second feature establish a process joint configured with a predetermined strength sufficient to maintain the second vehicle component relative to the first vehicle component in the location determined by the vision system.

3. The system of claim 2, wherein the first feature is a first fastening feature and the second feature is second fastening feature that is configured to engage with the first fastening feature.

4. The system of claim 1, further comprising an adhesive positioned between the first component and the second component establishing a process joint configured with a predetermined strength sufficient to maintain the second vehicle component relative to the first vehicle component in the location determined by the vision system.

5. The system of claim 4, wherein the adhesive has a thickness establishing a standoff distance between the first component and the second component; and
wherein the standoff distance is correlated with a subsequent structural weld of the first component to the second component.

6. The system of claim 1, further comprising:
binder-coated particles positioned between the first component and the second component establishing a process joint configured with a predetermined strength sufficient to maintain the second vehicle component relative to the first vehicle component in the location determined by the vision system; wherein the binder-coated particles have a thickness establishing a standoff distance between the first component and the second component; and
wherein the standoff distance is correlated with a subsequent structural weld of the first component to the second component.

7. The system of claim 1, further comprising:
a releasable adhesive positioned between the first component and the second component establishing a process joint configured with a predetermined strength sufficient to maintain the second component relative to the first component in the location determined by the vision system; wherein the releasable adhesive establishes a standoff distance between the first component and the second component; and
wherein the standoff distance is correlated with a subsequent structural weld of the first component to the second component.

8. The system of claim 1, wherein the support includes a shape memory polymer material having a temporary shape and a permanent shape; wherein the shape memory polymer establishes the permanent shape upon application of a predetermined activation stimulus; wherein the temporary shape is complementary to at least a portion of an outer surface of the first component; and wherein the support maintains the temporary shape during assembly of the first and the second components.

9. The system of claim 1, wherein the support includes:
a three-dimensional printed plastic core conforming to an outer surface of the first component; and
a liner covering a surface of the three-dimensional printed plastic core.

10. The system of claim 1, wherein the robotic system has a force sensor; and wherein the controller controls the robotic system to establish a predetermined holding force of the second component against the first component using a force level determined from the force sensor.

11. The system of claim 1, wherein the robotic system establishes a standoff distance between the first component and the second component; and
wherein the standoff distance is correlated with a subsequent structural weld of the first component to the second component.

12. The system of claim 1, wherein the robotic system includes:
a first robotic arm operatively holding the second component in the location determined by the vision system to establish a process joint with the support; and
a second robotic arm configured to weld the first component to the second component while the first robotic arm holds the second component in the location determined by the vision system.

13. The system of claim 12, wherein the support is another robotic arm or a repositionable support.

14. The system of claim 1, wherein the support includes a plurality of slidable pins configured to slide in unison different respective distances in conformance with an outer surface of the first component when the first component is placed on the slidable pins, the support thereby conforming to the outer surface of the first component.

15. A method of assembling components comprising:
determining a location of an unfixtured first component via a vision system having at least one camera;
retrieving the first component with a first robot based on the determined location;
placing the first component on a support without fixtures using the first robot;
determining the location of the first component on the support and the location of a second component via the vision system;
positioning the second component relative to the first component using the first robot or a second robot and based on the determined location of the first component on the support; and
holding the first component relative to the second component according to said positioning.

16. The method of claim 15, wherein said holding is by joining the first component to the second component with a process joint of a first predetermined strength; and further comprising:
after said joining, welding the first component to the second component with a structural joint of a second predetermined strength greater than the first predetermined strength; and wherein the positioning of the second component relative to the first component is maintained without fixtures and only by the process joint during said welding.

17. The method of claim 15, wherein said positioning is via one robot, and further comprising:
welding using an additional robot while said one robot maintains the positioning.

18. The method of claim 15, wherein said holding includes maintaining a predetermined force of the second component against the first component.

19. A releasable adhesive system, for joining a first component with a second component, comprising:
a primary material having (i) a first portion configured to be positioned in contact with a first surface of the first component, and (ii) a second portion, opposite the first portion, that is configured to be positioned in contact with a second surface of the second component;
wherein the first portion of the primary material positioned in contact with the portion of the first surface is configured to (i) maintain a bond with the first surface of the first component up to a first predetermined shear force being exerted on the first surface, (ii) maintain a bond with the first surface of the first component up to a first predetermined pull force being exerted on the first surface, and (iii) release the bond with the first surface of the first component in response to at least a first predetermined peel force being exerted on the first surface.

20. The releasable adhesive system of claim 19, wherein the second portion of the primary material positioned in contact with the second surface of the second component is configured to (i) maintain a bond with the second surface of the second component up to a second predetermined shear force being exerted on the second surface, (ii) maintain a bond with the second surface of the second component up to a second predetermined pull force being exerted on the second surface, and (iii) release the bond with the second surface of the second component in response to at least a second predetermined peel force exerted on the second surface.
